(19) United States
(12) Patent Application Publication
(10) Pub. No.: US 2026/0081482 A1
(43) Pub. Date: Mar. 19, 2026

(54) ELECTRONIC DEVICE FOR WIRELESSLY RECEIVING POWER AND OPERATING METHOD THEREOF

(71) Applicant: Samsung Electronics Co., Ltd., Suwon-si (KR)

(72) Inventors: Kangho BYUN, Suwon-si (KR); Yusu KIM, Suwon-si (KR); Bumjin PARK, Suwon-si (KR); Seho PARK, Suwon-si (KR); Jaesun SHIN, Suwon-si (KR); Mingi SONG, Suwon-si (KR); Juhyang LEE, Suwon-si (KR)

(21) Appl. No.: 19/400,679

(22) Filed: Nov. 25, 2025

Related U.S. Application Data
(63) Continuation of application No. PCT/KR2024/006551, filed on May 14, 2024.

(30) Foreign Application Priority Data
May 26, 2023 (KR) 10-2023-0068326
Sep. 20, 2023 (KR) 10-2023-0125437

(51) Int. Cl. H02J 50/80; H02J 7/00; H02J 50/10; H02J 50/90

(52) U.S. Cl. CPC H02J 50/80; H02J 7/42; H02J 7/47; H02J 7/685; H02J 50/10; H02J 50/90

(57) ABSTRACT

An electronic device is provided. The electronic device includes a housing, a wireless charging circuit, memory, comprising one or more storage media, storing instructions, and at least one processor communicatively coupled to the wireless charging circuit and the memory, wherein the instructions, when executed by the at least one processor individually or collectively, cause the electronic device to identify a mounting of an external device on the housing, identify a first charging mode, based on the mounting of the external device, identify the first charging mode as a preferred charging mode from among a plurality of charging modes including the first charging mode, receive a first ping signal from a wireless power transmission device via the wireless charging circuit, transmit, to the wireless power transmission device via the wireless charging circuit, information indicating that the first charging mode is supported, based on receiving the first ping signal, and receive first charging power from the wireless power transmission device via the wireless charging circuit based on the first charging mode and based on the wireless power transmission device supporting the first charging mode.

### CROSS-REFERENCE TO RELATED APPLICATION(S)

This application is a continuation application, claiming priority under 35 U.S.C. § 365 (c), of an International application No. PCT/KR2024/006551, filed on May 14, 2024, which is based on and claims the benefit of a Korean patent application number 10-2023-0068326, filed on May 26, 2023, in the Korean Intellectual Property Office, and of a Korean patent application number 10-2023-0125437, filed on Sep. 20, 2023, in the Korean Intellectual Property Office, the disclosure of each of which is incorporated by reference herein in its entirety.

### BACKGROUND

### 1. Field

The disclosure relates to an electronic device for wirelessly receiving power and an operating method thereof.

### 2. Description of Related Art

The wireless power transmission technology is a scheme for transmitting power using an electromagnetic field induced in a coil. A wireless power transmission device applies a current to a transmission coil to generate an electromagnetic field, and an induced electromotive force is formed in a reception coil of a wireless power reception device by the generated electromagnetic field, so that power can be transmitted wirelessly.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device for wirelessly receiving power and an operating method thereof.

Additional aspects will be set forth in part in the description which follows and, in part, will be apparent from the description, or may be learned by practice of the presented embodiments.

In accordance with an aspect of the disclosure, an electronic device is provided. The electronic device includes a housing, a wireless charging circuit, memory, comprising one or more storage media, storing instructions, and at least one processor communicatively coupled to the wireless charging circuit and the memory, wherein the instructions, when executed by the at least one processor individually or collectively, cause the electronic device to identify a mounting of an external device on the housing, identify a first charging mode based on the mounting of the external device, identify the first charging mode as a preferred charging mode from among a plurality of charging modes including the first charging mode, receive a first ping signal from a wireless power transmission device via the wireless charging circuit, transmit, to the wireless power transmission device via the wireless charging circuit, information indicating that the first charging mode is supported, based on receiving the first ping signal, and receive first charging power from the wireless power transmission device via the wireless charging circuit based on the first charging mode and based on the wireless power transmission device supporting the first charging mode.

In accordance with another aspect of the disclosure, a method of operating the electronic device is provided. The method includes identifying a mounting of an external device on a housing of the electronic device, identifying a first charging mode based on the mounting of the external device, identifying the first charging mode as a preferred charging mode from among a plurality of charging modes including the first charging mode, receiving a first ping signal from a wireless power transmission device via the wireless charging circuit transmitting, to the wireless power transmission device via the wireless charging circuit, information indicating that the first charging mode is supported, based on receiving the first ping signal, and receiving, based on the wireless power transmission device supporting the first charging mode, first charging power from the wireless power transmission device via the wireless charging circuit based on the first charging mode.

In accordance with another aspect of the disclosure, one or more non-transitory computer-readable storage media storing one or more computer programs including computer-executable instructions that when executed by one or more processors of an electronic device individually or collectively, cause the electronic device to perform operations is provided. The operations including identifying a mounting of an external device on a housing of the electronic device, identifying a first charging mode based on the mounting of the external device, identifying the first charging mode as a preferred charging mode from among a plurality of charging modes including the first charging mode, receiving a first ping signal from a wireless power transmission device via the wireless charging circuit of the electronic device, transmitting, to the wireless power transmission device via the wireless charging circuit, information indicating that the first charging mode is supported, based on receiving the first ping signal, and receiving, based on the wireless power transmission device supporting the first charging mode, first charging power from the wireless power transmission device via the wireless charging circuit based on the first charging mode.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram of a wireless power transmission device and an electronic device according to an embodiment of the disclosure;

FIG. 3 is a diagram illustrating an electronic device and an external device, according to an embodiment of the disclosure;

FIG. 4 is a diagram illustrating a display and a digitizer of an electronic device, according to an embodiment of the disclosure;

FIG. 5A and FIG. 5B are diagrams illustrating an operation of an electronic device according to an embodiment of the disclosure;

FIG. 6 is a flowchart of a method of operating an electronic device according to an embodiment of the disclosure;

FIG. 7 is a flowchart of a method of operating an electronic device according to an embodiment of the disclosure;

FIG. 8 is a diagram illustrating a charging mode according to an embodiment of the disclosure;

FIG. 9 is a diagram illustrating an operation of an electronic device according to an embodiment of the disclosure;

FIG. 10 is a flowchart of a method of operating an electronic device according to an embodiment of the disclosure;

FIG. 11 is a flowchart of a method of operating an electronic device according to an embodiment of the disclosure;

FIG. 12 is a diagram illustrating an operation of an electronic device according to an embodiment of the disclosure;

FIG. 13 is a flowchart of a method of operating an electronic device according to an embodiment of the disclosure;

FIG. 14 is a flowchart of a method of operating an electronic device according to an embodiment of the disclosure;

FIG. 15 is a flowchart of a method of operating an electronic device according to an embodiment of the disclosure;

FIG. 16 is a flowchart of a method of operating an electronic device according to an embodiment of the disclosure;

FIG. 17 is a flowchart of a method of operating an electronic device according to an embodiment of the disclosure; and

FIG. 18 is a flowchart of a method of operating an electronic device according to an embodiment of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

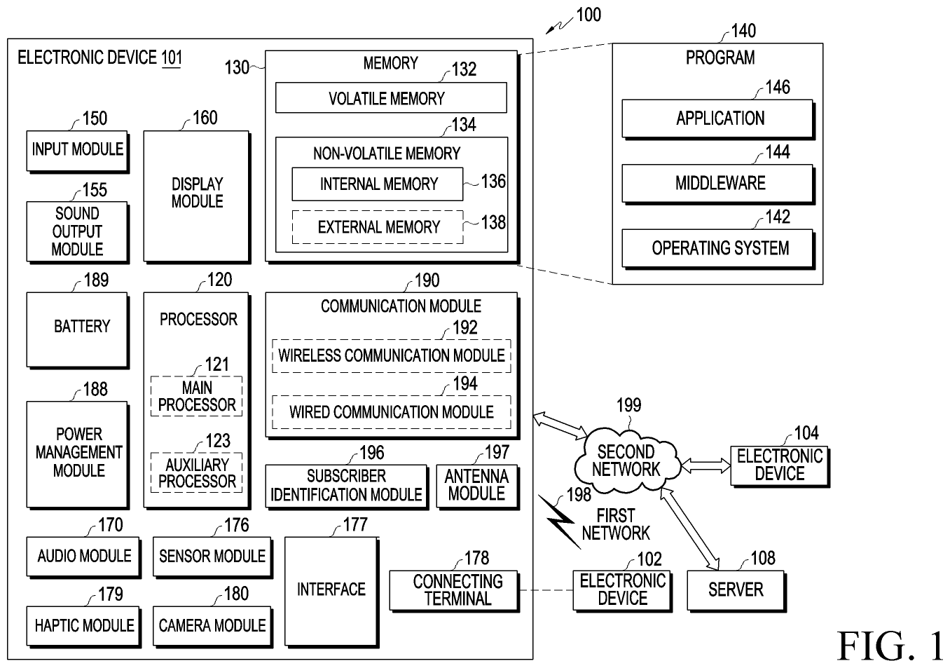

FIG. 1 is a block diagram illustrating an electronic device in a network environment 100 according to an embodiment of the disclosure.

Referring to FIG. 1, the electronic device 101 in the network environment 100 may communicate with an external electronic device 102 via a first network 198 (e.g., a short-range wireless communication network), or an external electronic device 104 or a server 108 via a second network 199 (e.g., a long-range wireless communication network). According to an embodiment, the electronic device 101 may communicate with the external electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least portion of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as portion of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as portion of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as portion of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a second sensor module configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment, the interface 177 may include, for example, a high-definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least portion of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local region network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth-generation (5G) network, a next-generation communication network, the Internet, or a computer network (e.g., local region network (LAN) or wide region network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth-generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other portions (e.g., radio frequency integrated circuit (RFIC)) than the radiator may be further formed as portion of the antenna module 197.

According to an embodiment, the antenna module 197 may form a mm Wave antenna module. According to an embodiment, the mm Wave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least portion of the function or the service. The one or more external electronic devices receiving the request may perform the at least portion of the function or the service requested, or an additional function or an additional service related to the request, and transfer an outcome of the performing to the electronic device 101. The electronic device 101 may provide the outcome, with or without further processing of the outcome, as at least portion of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (loT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or health-care) based on 5G communication technology or IoT-related technology.

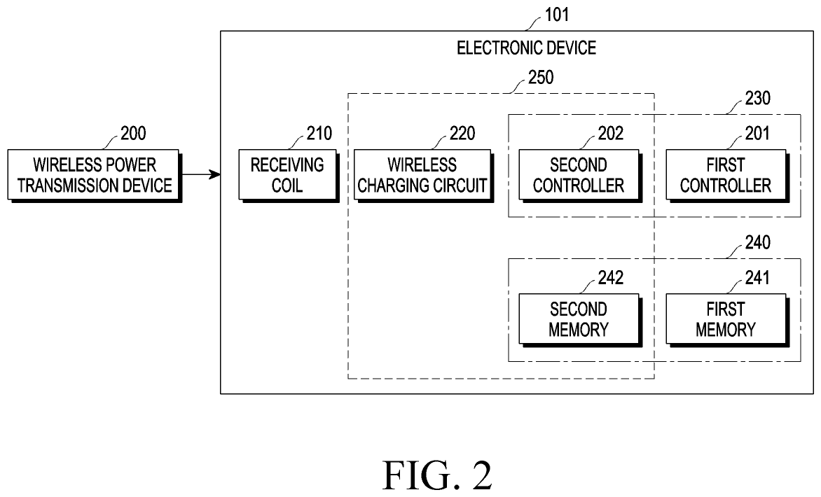

FIG. 2 is a block diagram of a wireless power transmission device 200 and an electronic device 101 according to an embodiment of the disclosure.

Referring to FIG. 2, the wireless power transmission device 200 according to an embodiment may wirelessly transmit power to the electronic device 101. The wireless power transmission device 200 may receive information from the electronic device 101. For example, the wireless power transmission device 200 may transmit power based on an inductive method. In a case where the wireless power transmission device 200 transmits power based on the inductive method, the wireless power transmission device 200 may include, for example, at least one of a power source, a direct current-direct current (DC/DC) conversion circuit, a direct current-alternating current (DC/AC) conversion circuit (e.g., an inverter), an amplification circuit, an impedance matching circuit, at least one capacitor, at least one coil, or a communication modulation circuit. The at least one capacitor together with the at least one coil may form a resonant circuit. The wireless power transmission device 200 may implement at least a part of a method defined in the Qi standard of the Wireless Power Consortium (WPC). The wireless power transmission device 200 may include a coil capable of generating an inductive magnetic field when current flows based on the inductive method. The operation in which the wireless power transmission device 200 generates the inductive magnetic field may be expressed as the wireless power transmission device 200 wirelessly transmitting power. In addition, in a coil (e.g., reception coil 210) of the electronic device 101, an induced electromotive force (or current, voltage, and/or power) may be generated by a magnetic field formed in the vicinity based on a resonant method or an inductive method. The process in which the induced electromotive force is generated through the coil (e.g., reception coil 210) may be expressed as the electronic device 101 wirelessly receiving power. The electronic device 101 according to an embodiment may include a wireless charging circuit 220. The wireless charging circuit 220 may include at least one of an alternating current-direct current (AC/DC) conversion circuit (e.g., a rectifier), a DC/DC conversion circuit, or a communication modulation circuit.

The wireless power transmission device 200 according to an embodiment may communicate with the electronic device 101. For example, the wireless power transmission device 200 may communicate with the electronic device 101 based on an in-band method. The wireless power transmission device 200 may modulate data to be transmitted, for example, based on a frequency shift keying (FSK) modulation scheme, and the electronic device 101 may provide information by performing modulation based on an amplitude shift keying (ASK) modulation scheme. The wireless power transmission device 200 may identify information provided by the electronic device 101 based on the amplitude of current and/or voltage applied to a transmission coil. To provide the information, the electronic device 101 may control the on/off of at least one internal switch. An operation of performing modulation based on the ASK modulation scheme and/or the FSK modulation scheme may be understood as an operation of transmitting data (or a packet) according to an in-band communication method, and an operation of performing demodulation based on an ASK demodulation scheme and/or an FSK demodulation scheme may be understood as an operation of receiving data (or a packet) according to the in-band communication method.

The electronic device 101 according to an embodiment may include a controller 230. The controller 230 of FIG. 2 may include the processor 120 of FIG. 1. The electronic device 101 according to an embodiment may include memory 240. The memory 240 of FIG. 2 may include the memory 130 of FIG. 1.

In this disclosure, when the wireless power transmission device 200 or the electronic device 101 is described as performing a specific operation, it may mean that various hardware components included in the wireless power transmission device 200 or the electronic device 101—for example, a controller 230 such as a processor (e.g., a micro-controlling unit (MCU), a field-programmable gate array (FPGA), an application-specific integrated circuit (ASIC), a microprocessor, or an application processor (AP))-perform the specific operation. When the wireless power transmission device 200 or the electronic device 101 is described as performing a specific operation, it may also mean that the controller 230 controls other hardware to perform the specific operation. When the wireless power transmission device 200 or the electronic device 101 is described as performing a specific operation, it may also mean that at least one instruction for performing the specific operation, stored in a storage circuit (e.g., memory 130 in FIG. 1) of the wireless power transmission device 200 or the electronic device 101, is executed, thereby causing the controller 230 or other hardware to perform the specific operation.

According to an embodiment, the controller 230 may include a first controller 201 (e.g., the processor 120 of FIG. 1) and a second controller 202 (e.g., a controller corresponding to the wireless charging circuit 220). Even when the controller 230 is implemented as multiple controllers, for convenience of description, operations may be described as “operation of the electronic device 101,” “operation of the controller 230,” or “operation of at least one controller 230.” According to an embodiment, the memory 240 may include first memory 241 (e.g., memory 130 in FIG. 1) and second memory 242 (e.g., memory corresponding to the wireless charging circuit 220). According to an embodiment, the second controller 202, the second memory 242, and the wireless charging circuit 220 may be integrated into a single circuit 250 (e.g., an integrated circuit (IC)) or may be implemented as separate circuits.

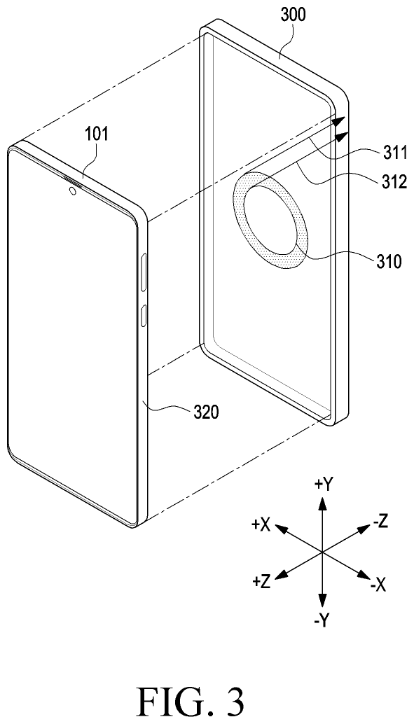

FIG. 3 is a diagram illustrating an electronic device 101 and an external device 300 according to an embodiment of the disclosure.

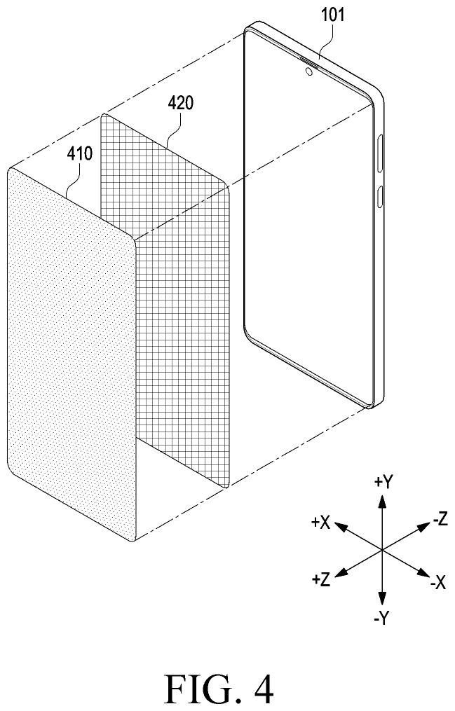

According to an embodiment, the external device 300 (e.g., a cover device) may be a device mountable to the electronic device 101. The external device 300 may be mounted to or detached from the housing 320 of the electronic device 101. The external device 300 may include a magnet 310. For example, referring to FIG. 3, the magnet 310 may be in a donut shape with a hollow center. For example, the magnet 310 may be implemented in a donut shape with a hollow center. For example, the magnet 310 may be formed by coupling a plurality of members to define a donut shape with a hollow center. In a case where the magnet 310 is formed of a plurality of coupled members, the number of members and the size of each member are not limited. According to an embodiment, an outer side of the magnet 310 may have a first polarity (e.g., an N pole) in the −Z direction of FIG. 3, and the inner side may have a second polarity (e.g., an S pole) in the −Z direction. The outer side of the magnet 310 may have the first polarity (e.g., an N pole) in the −Z direction of FIG. 3 and the second polarity (e.g., an S pole) in the +Z direction. The inner side may have the second polarity (e.g., an S pole) in the −Z direction and the first polarity (e.g., an N pole) in the +Z direction. The electronic device 101 may identify the mounting of the external device 300. For example, the electronic device 101 may identify the mounting of the external device 300 through a sensor module 176 (e.g., a Hall sensor). For example, the electronic device 101 may identify the mounting of the external device 300 through communication (e.g., wired or wireless communication) with a communication circuit (e.g., a wired or wireless communication circuit) included in the external device 300. For example, the electronic device 101 may identify the mounting of the external device 300 based on authentication through communication (e.g., wired communication or wireless communication) with the communication circuit (e.g., a wired communication circuit or a wireless communication circuit) included in the external device 300. For example, the electronic device 101 may identify the mounting of the external device 300 by detecting a change in an internal circuit characteristic (e.g., a change in impedance). For example, the electronic device 101 may identify the mounting of the external device 300 through a digitizer (e.g., the digitizer 420 of FIG. 4), which will be described later.

FIG. 4 is a diagram illustrating a display 410 and a digitizer 420 of an electronic device 101 according to an embodiment of the disclosure.

According to an embodiment, the electronic device 101 may include the display 410 (e.g., the display module 160 of FIG. 1) and the digitizer 420. The display 410 may be disposed on a front surface (e.g., the +Z-axis direction in the electronic device 101 of FIG. 4) of the housing (e.g., 320 of FIG. 3) of the electronic device 101. The digitizer 420 may be disposed on a lower side (e.g., the −Z-axis direction of the display 410 in FIG. 4) of the display 410. The digitizer 420 may convert movement of an accessory device (e.g., a stylus pen) or a body part (e.g., a finger) on the display 410 into a digital signal based on an electromagnetic induction method. The electronic device 101 may identify an object (e.g., the accessory device or the body part) on the display 410 (or a window disposed on the display 410) through the digitizer 420. The electronic device 101 may identify the mounting of the external device 300 based on sensitivities detected in a plurality of regions of the digitizer 420.

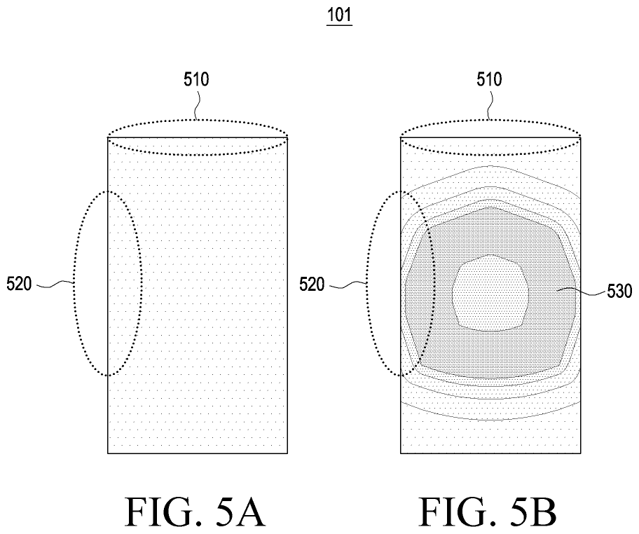

FIG. 5A and FIG. 5B are diagrams illustrating an operation of an electronic device 101 according to an embodiment of the disclosure.

FIG. 5A and FIG. 5B are diagrams illustrating sensitivities in a plurality of regions of the digitizer 420 of the electronic device 101.

Referring to FIG. 5A and FIG. 5B, an operation of identifying the mounting of the external device 300 may be understood. FIG. 5A illustrates a state in which the external device 300 is not mounted on the electronic device 101. FIG. 5B illustrates a state in which the external device 300 is mounted on the electronic device 101. In a state in which the external device 300 is mounted on the electronic device 101, a magnetic-field pattern 530 may be formed by the magnet 310 of the external device 300.

According to an embodiment, the magnet 310 of the external device 300 may have a donut shape, resulting in a magnetic-field pattern 530 based on the donut-shaped arrangement. The electronic device 101 may include a sensor member (e.g., sensor 176 of FIG. 1) (e.g., a Hall sensor, a digitizer) capable of detecting the magnetic-field pattern according to the donut-shaped arrangement. For example, an outer side of the magnet 310 may have a first polarity (e.g., an N pole) in the −Z direction of FIG. 3, and an inner side may have a second polarity (e.g., an S pole) in the −Z direction, and the electronic device 101 may include a sensor capable of detecting a magnetic-field pattern based on the magnet 310. For example, the electronic device 101 (e.g., the controller 230) may identify the magnet 310 of the external device 300 based on sensing values obtained using at least one sensor (e.g., sensor 176 of FIG. 1).

According to an embodiment, the electronic device 101 (e.g., the controller 230) may detect a magnetic field caused by the magnet 310 of the external device 300 using at least one sensor (e.g., sensor 176 of FIG. 1) and may detect a difference (or change) in magnetic-field sensitivity in at least one region. For example, the sensor 176 of FIG. 1 may include a first Hall sensor and a second Hall sensor, the first Hall sensor may detect a difference in magnetic-field sensitivity of a first region of the electronic device 101, and the second Hall sensor may detect a difference in magnetic-field sensitivity of a second region of the electronic device 101.

According to an embodiment, the electronic device 101 (e.g., the controller 230) may identify the mounting (or the detachment) of the external device 300 based on a difference (or change) in sensitivities of a first region 510 of the digitizer 420. According to an embodiment, the electronic device 101 (e.g., the controller 230) may identify the mounting (or detachment) of the external device 300 based on a difference (or change) in sensitivities of a second region 520 of the digitizer 420. According to an embodiment, the electronic device 101 (e.g., the controller 230) may identify the mounting (or detachment) of the external device 300 based on a difference (or change) in sensitivities of the first region 510 of the digitizer 420 and a difference (or change) in sensitivities of the second region 520 of the digitizer 420. A first distance between the first region 510 of the digitizer 420 and the magnet 310 of the external device 300 may be greater than a second distance between the second region 520 of the digitizer 420 and the magnet 310 of the external device 300. The first region 510 of the digitizer 420 may have a relatively small difference in sensitivities caused by the mounting and detachment of the external device 300. The second region 520 of the digitizer 420 may have a relatively large difference in sensitivities caused by the mounting and detachment of the external device 300. For example, the electronic device 101 (e.g., the controller 230) may identify the mounting (or detachment) of the external device 300 based on a difference between first sensitivities of a first region 510 of the digitizer 420 at a first time (e.g., a state in which the external device 300 is not mounted on the electronic device 101) and second sensitivities of the first region 510 of the digitizer 420 at a second time (e.g., a state in which the external device 300 is mounted on the electronic device 101) being greater than or equal to a first reference value. For example, the electronic device 101 (e.g., the controller 230) may identify the mounting (or detachment) of the external device 300 based on a difference between third sensitivities of a second region 520 of the digitizer 420 at a third time (e.g., a state in which the external device 300 is not mounted on the electronic device 101) and fourth sensitivities of the second region 520 of the digitizer 420 at a fourth time (e.g., a state in which the external device 300 is mounted on the electronic device 101) being greater than or equal to a second reference value. For example, the electronic device 101 (e.g., the controller 230) may identify the mounting (or detachment) of the external device 300 based on both a difference between fifth sensitivities of the first region 510 of the digitizer 420 at a fifth time (e.g., a state in which the external device 300 is not mounted on the electronic device 101) and sixth sensitivities of the first region 510 of the digitizer 420 at a sixth time (e.g., a state in which the external device 300 is mounted on the electronic device 101) being greater than or equal to the first reference value, and a difference between seventh sensitivities of the second region 520 of the digitizer 420 at the fifth time and eighth sensitivities of the second region 520 of the digitizer 420 at the sixth time being greater than or equal to the second reference value. The second reference value corresponding to the second region 520 may be less than or equal to the first reference value corresponding to the first region 510, but the magnitudes of the first reference value and the second reference value are not limited.

According to an embodiment, the electronic device 101 (e.g., the controller 230) may identify the mounting (or detachment) of the external device 300 based on a difference between first sensitivities of a first region 510 of the digitizer 420 and second sensitivities of a second region 520 of the digitizer 420. The electronic device 101 may identify a mounting of the external device 300 (e.g., a coupled state (e.g., FIG. 5B)) based on the difference between the first sensitivities of the first region 510 of the digitizer 420 and the second sensitivities of the second region 520 of the digitizer 420 being greater than or equal to a reference value. The electronic device 101 may identify the detachment of the external device 300 (e.g., a decoupled state (e.g., FIG. 5A)) based on the difference between the first sensitivities of the first region 510 of the digitizer 420 and the second sensitivities of the second region 520 of the digitizer 420 being less than the reference value.

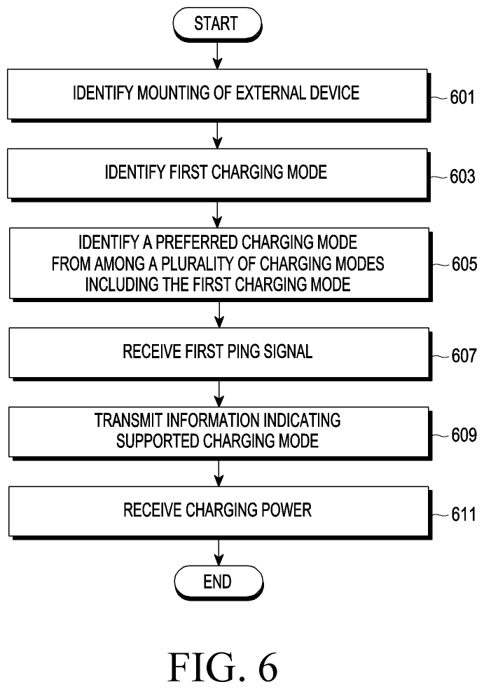

FIG. 6 is a flowchart of a method of operating an electronic device 101 according to an embodiment of the disclosure.

FIG. 6 may be described with reference to the embodiment described above.

At least some of the operations of FIG. 6 may be omitted. An execution order of the operations of FIG. 6 may be changed. Operations other than those of FIG. 6 may be performed before, during, or after the execution of the operations of FIG. 6.

Referring to FIG. 6, in operation 601, according to an embodiment, the electronic device 101 (e.g., the controller 230) may identify the mounting of the external device 300. For example, the electronic device 101 may identify the mounting of the external device 300 through a sensor module 176 (e.g., a Hall sensor). The sensor module 176 may detect the magnet 310 disposed in the external device 300. The magnet 310 may have a circular configuration formed by coupling a plurality of magnetic members. The outer side of each magnetic member may have a first polarity (e.g., an N pole) in a first direction, and the inner side of each magnetic member may have a second polarity (e.g., an S pole) in the first direction. The sensor module 176 may determine the state of the magnetic field associated with magnets arranged in a circular configuration and may identify the mounting of the external device 300 or whether the external device 300 includes magnets arranged in the circular configuration. For example, the electronic device 101 may identify the mounting of the external device 300 through communication (e.g., wired or wireless communication) with a communication circuit included in the external device 300. For example, the electronic device 101 may identify the mounting of the external device 300 based on authentication through communication (e.g., wired or wireless communication (e.g., NFC)) with a communication circuit included in the external device 300. For example, the electronic device 101 may identify the mounting of the external device 300 by detecting a change in an internal circuit characteristic (e.g., a change in impedance). For example, the electronic device 101 may identify the mounting of the external device 300 through the digitizer 420. For example, the electronic device 101 may identify the mounting of the external device 300 based on the difference between first sensitivities of a first region 510 of the digitizer 420 and second sensitivities of a second region 520 of the digitizer 420 being greater than or equal to a reference value, thereby identifying a mounted state of the external device 300 (e.g., a coupled state (e.g., FIG. 5B)). For example, the electronic device 101 may also identify the mounting of the external device 300 by a combination of the examples described in operation 601.

In operation 603, according to an embodiment, the electronic device 101 (e.g., the controller 230) may identify a first charging mode. Based on the mounting of the external device 300, the electronic device 101 may identify that the first charging mode (e.g., a first fast-charging mode) associated with the magnet 310 of the external device 300 is supported. For example, the electronic device 101 may not support the first charging mode by itself, and when the external device 300 is mounted on the electronic device 101, it may be identified that the electronic device 101 supports the first charging mode via the external device 300. For example, the electronic device 101 may support the first charging mode by itself, and when the external device 300 is mounted on the electronic device 101, it may be identified that the electronic device 101 supports the first charging mode via the external device 300. The first charging mode of operation 603 may be the first fast-charging mode of FIG. 8 (e.g., a charging mode corresponding to a magnetic power profile (MPP)), which will be described later.

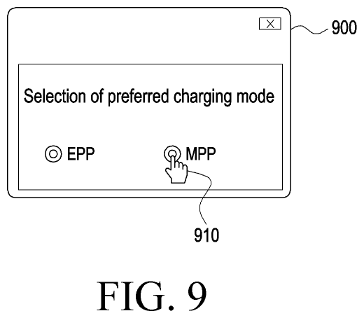

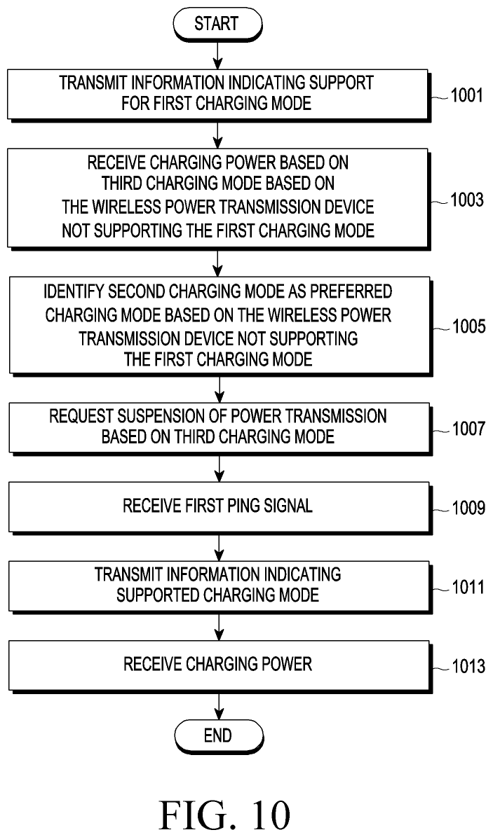

In operation 605, according to an embodiment, the electronic device 101 (e.g., the controller 230) may identify a preferred charging mode among a plurality of charging modes including the first charging mode. The electronic device 101 may identify the preferred charging mode among the plurality of charging modes including the first charging mode, based on a mounting of the external device 300. For example, the electronic device 101 may identify the first charging mode as the preferred charging mode. The electronic device 101 may support a plurality of charging modes, which may include a first charging mode, a second charging mode, and a third charging mode. The first charging mode may be a first fast charging mode (e.g., a charging mode corresponding to a magnetic power profile (MPP)). The second charging mode may be a second fast charging mode (e.g., a charging mode corresponding to an extended power profile (EPP)). The third charging mode may be a slow charging mode (e.g., a baseline power profile (BPP)). The plurality of charging modes may further include other charging modes. The electronic device 101 may identify the preferred charging mode among the plurality of charging modes. For example, the electronic device 101 may identify the preferred charging mode based on a user input, as in the embodiment of FIG. 9 described later. For example, the electronic device 101 may identify the preferred charging mode based on an event (e.g., operation 1005), as in the embodiment of FIG. 10 described later. For example, the electronic device 101 may identify the preferred charging mode based on data stored in memory (e.g., the memory 130 of FIG. 1).

In operation 607, according to an embodiment, the electronic device 101 (e.g., the controller 230) may receive a ping signal (e.g., a first ping signal) from the wireless power transmission device 200 via the wireless charging circuit 220. The wireless power transmission device 200 may transmit a ping signal (e.g., a digital ping signal). The electronic device 101 may receive the ping signal (e.g., the digital ping signal) (e.g., the first ping signal) from the wireless power transmission device 200 via the wireless charging circuit 220, based on the ping signal (e.g., the digital ping signal) transmitted from the wireless power transmission device 200.

In operation 609, according to an embodiment, the electronic device 101 (e.g., the controller 230) may transmit information on a supported charging mode to the wireless power transmission device 200. The information on the supported charging mode may be information indicating that a specific charging mode is supported. The information on the supported charging mode may include information on a charging mode corresponding to a preferred charging mode. The electronic device 101 may transmit the information on the supported charging mode to the wireless power transmission device 200 via the wireless charging circuit 220 based on receiving a ping signal (e.g., a digital ping signal) (e.g., a first ping signal). The electronic device 101 may identify a preferred charging mode and may transmit information on a charging mode corresponding to the preferred charging mode to the wireless power transmission device 200. In a case where the first charging mode is identified as the preferred charging mode in operation 605, the electronic device 101 may transmit, to the wireless power transmission device 200 via the wireless charging circuit 220, information indicating that the first charging mode is supported, based on receiving the ping signal. For example, the electronic device 101 may transmit an identification data (ID) packet based on receiving the ping signal and then may transmit an extended identification data (XID) packet. For example, after transmitting the ID packet including information indicating that the XID packet will be transmitted, the electronic device 101 may transmit the XID packet including information on the supported charging mode. According to an embodiment, even when the electronic device 101 supports a plurality of charging modes (e.g., a first charging mode, a second charging mode, and a third charging mode), the electronic device 101 may transmit, to the wireless power transmission device 200, the XID packet including information on a charging mode (e.g., the first charging mode) identified as the preferred charging mode. The XID packet transmitted from the electronic device 101 to the wireless power transmission device 200 may include information on one charging mode (e.g., the charging mode identified as the preferred charging mode) among a plurality of charging modes (e.g., the first charging mode, the second charging mode, and the third charging mode) supported by the electronic device 101.

In operation 611, according to an embodiment, the electronic device 101 (e.g., the controller 230) may receive charging power from the wireless power transmission device 200. After transmitting information on the first charging mode to the wireless power transmission device 200 in operation 609, the electronic device 101 may receive first charging power from the wireless power transmission device 200 via the wireless charging circuit 220, based on the wireless power transmission device 200 supporting the first charging mode. The electronic device 101 may proceed with a configuration phase and/or a negotiation phase related to the first charging mode with the wireless power transmission device 200, based on the wireless power transmission device 200 supporting the first charging mode, and may receive the first charging power from the wireless power transmission device 200 via the wireless charging circuit 220 based on the first charging mode. The electronic device 101 may identify a preferred charging mode, may transmit information on the charging mode identified as the preferred charging mode to the wireless power transmission device 200, and may receive, based on the wireless power transmission device 200 supporting the preferred charging mode, charging power from the wireless power transmission device 200 via the wireless charging circuit 220 based on the preferred charging mode. According to an embodiment, after performing operation 611, the electronic device 101 (e.g., the controller 230) may display a screen indicating that charging power is received based on the first charging mode (e.g., a charging mode corresponding to MPP).

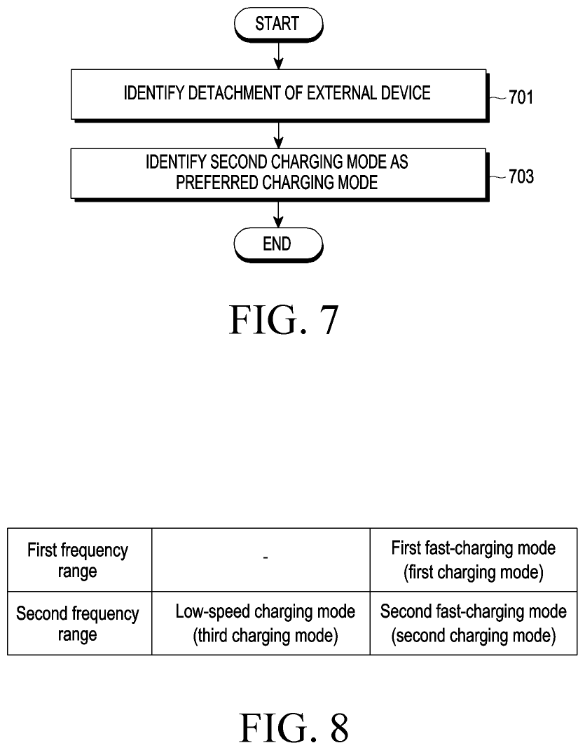

FIG. 7 is a flowchart of a method for operating an electronic device 101 according to an embodiment of the disclosure.

FIG. 7 may be described with reference to the embodiments described above.

At least some of the operations illustrated in FIG. 7 may be omitted. The execution order of the operations shown in FIG. 7 may be changed. Operations other than the operations of FIG. 7 may be performed before, during, or after performing the operations of FIG. 7.

Referring to FIG. 7, in operation 701, according to an embodiment, the electronic device 101 (e.g., the controller 230) may identify detachment of an external device 300. After identifying the mounting of the external device 300, the electronic device 101 may identify detachment of the external device 300. After identifying a first charging mode (e.g., a first fast charging mode) supported by the mounting of the external device 300 as a preferred charging mode, the electronic device 101 may identify detachment of the external device 300. The electronic device 101 may identify the detachment of the external device 300 after identifying the first charging mode as the preferred charging mode from among a plurality of charging modes, including a second charging mode (e.g., a charging mode corresponding to EPP) and the first charging mode (e.g., a charging mode corresponding to MPP), supported by the mounting of the external device 300.

In operation 703, according to an embodiment, the electronic device 101 (e.g., the controller 230) may identify a second charging mode (e.g., a second fast charging mode) as a preferred charging mode from among a plurality of charging modes, based on detachment of the external device 300. A frequency range of the second charging mode may differ from a frequency range of the first charging mode. According to an embodiment, the electronic device 101 may identify a second charging mode (e.g., a second fast charging mode) as a preferred charging mode from among a plurality of charging modes, based on detachment of an external device 300, when the electronic device 101 is in a state where the external device 300 is detached and based on the fact that the electronic device 101 itself does not support the first charging mode (e.g., the first fast charging mode). For example, the electronic device 101 may identify the second charging mode as the preferred charging mode from among the plurality of charging modes, based on the detachment of the external device 300, without a separate user input. For example, the electronic device 101 may display a screen for selecting a preferred charging mode based on detachment of the external device 300, and may identify the second charging mode as the preferred charging mode among the plurality of charging modes based on a user input.

According to an embodiment, in a state where the external device 300 is detached, the electronic device 101 (e.g., the controller 230) may continue to identify a first charging mode (e.g., a first fast charging mode) as the preferred charging mode, based on the electronic device 101 itself supporting the first charging mode (e.g., the first fast charging mode).

FIG. 8 is a diagram illustrating charging modes according to an embodiment of the disclosure.

Referring to FIG. 8, a plurality of charging modes supported by the electronic device 101 may be understood.

According to an embodiment, the electronic device 101 may support a first charging mode. The first charging mode may be a first fast charging mode (e.g., a charging mode corresponding to MPP). The first charging mode may be a charging mode that follows MPP. For example, the electronic device 101 may not support the first charging mode by itself, and it may be identified that the electronic device 101 supports the first charging mode through the external device 300 when the external device 300 is mounted on the electronic device 101. For example, the electronic device 101 may also support the first charging mode by itself, and it may be identified that the electronic device 101 supports the first charging mode through the external device 300 when the external device 300 is mounted on the electronic device 101.

According to an embodiment, the electronic device 101 may support a second charging mode. The second charging mode may be a second fast charging mode (e.g., a charging mode corresponding to EPP). The second charging mode may be a charging mode that follows EPP. For example, the electronic device 101 may support the second charging mode by itself, regardless of the external device 300. A frequency range of the second charging mode (e.g., a second frequency range) may differ from a frequency range of the first charging mode (e.g., a first frequency range).

According to an embodiment, the electronic device 101 may support a third charging mode. The third charging mode may be a slow charging mode (e.g., a charging mode corresponding to BPP). The third charging mode may be a charging mode that follows BPP. For example, the electronic device 101 may support the third charging mode by itself, regardless of the external device 300. A frequency range of the third charging mode (e.g., a slow charging mode) may be the same as a frequency range of the second charging mode (e.g., a second fast charging mode).

The electronic device 101 according to an embodiment may attempt charging in a first charging mode (e.g., a charging mode corresponding to MPP) and may perform charging in a second charging mode (e.g., a charging mode corresponding to EPP), based on the wireless power transmission device 200 not supporting the first charging mode.

FIG. 9 is a diagram illustrating an operation of an electronic device according to an embodiment of the disclosure.

According to an embodiment, the electronic device 101 (e.g., the controller 230) may identify a preferred charging mode based on a user input 910. For example, the electronic device 101 may identify the preferred charging mode from among a plurality of supported charging modes. The electronic device 101 may display, on a display 410 (e.g., the display module 160), a screen 900 for selecting a preferred charging mode from among the plurality of charging modes. A user may provide a user input 910 selecting one charging mode on the screen 900. The electronic device 101 may identify the preferred charging mode from among the plurality of charging modes based on the user input 910 provided through the screen 900 for selecting the preferred charging mode.

According to an embodiment, the electronic device 101 (e.g., the controller 230) may display a screen 900 for selecting a preferred charging mode based on the mounting of the external device 300. For example, the electronic device 101 may identify a first charging mode (e.g., a charging mode corresponding to MPP) based on the mounting of the external device 300 and may display the screen 900 for selecting a preferred charging mode from among a plurality of charging modes including the first charging mode and a second charging mode (e.g., a charging mode corresponding to EPP). The electronic device 101 may identify the first charging mode as the preferred charging mode based on a user input 910 selecting the first charging mode (e.g., the charging mode corresponding to MPP) on the screen 900 for selecting a preferred charging mode. The electronic device 101 may identify the second charging mode as the preferred charging mode based on a user input selecting the second charging mode (e.g., the charging mode corresponding to EPP) on the screen 900 for selecting a preferred charging mode.

According to an embodiment, the electronic device 101 (e.g., the controller 230) may display a screen 900 for selecting a preferred charging mode regardless of the mounting of the external device 300 (e.g., whether the external device 300 is mounted or not). For example, the electronic device 101 may support a first charging mode (e.g., a charging mode corresponding to MPP) by itself. The electronic device 101 may display the screen 900 for selecting a preferred charging mode from among a plurality of charging modes including the first charging mode (e.g., a charging mode corresponding to MPP) and a second charging mode (e.g., a charging mode corresponding to EPP), regardless of the mounting of the external device 300 (e.g., whether the external device 300 is mounted or not). The electronic device 101 may identify the first charging mode as the preferred charging mode based on a user input 910 selecting the first charging mode (e.g., the charging mode corresponding to MPP) on the screen 900 for selecting a preferred charging mode. The electronic device 101 may identify a second charging mode (e.g., a charging mode corresponding to EPP) as the preferred charging mode based on a user input selecting the second charging mode on the screen 900 for selecting a preferred charging mode.

FIG. 10 is a flowchart of a method of operating an electronic device according to an embodiment of the disclosure. FIG. 10 may be described with reference to the embodiment described above. At least some of the operations of FIG. 10 may be omitted. An execution order of the operations of FIG. 10 may be changed. Operations other than those of FIG. 10 may be performed before, during, or after the execution of the operations of FIG. 10.

Referring to FIG. 10, in operation 1001, according to an embodiment, the electronic device 101 (e.g., the controller 230) may transmit, to the wireless power transmission device 200, information indicating that a first charging mode (e.g., a charging mode corresponding to MPP) is supported. For example, in operation 609, the electronic device 101 may transmit, to the wireless power transmission device 200, information indicating that the first charging mode (e.g., the charging mode corresponding to MPP) is supported.

In operation 1003, according to an embodiment, the electronic device 101 (e.g., the controller 230) may receive charging power from the wireless power transmission device 200 via the wireless charging circuit 220, based on the wireless power transmission device 200 supporting a third charging mode (e.g., a charging mode corresponding to BPP), and based on the wireless power transmission device 200 not supporting the first charging mode. For example, the electronic device 101 may attempt charging in a first fast charging mode (e.g., a charging mode corresponding to MPP), but may receive charging power from the wireless power transmission device 200 based on a slow charging mode (e.g., a charging mode corresponding to BPP), based on the wireless power transmission device 200 not supporting the first fast charging mode.

In operation 1005, according to an embodiment, the electronic device 101 (e.g., the controller 230) may identify a second charging mode (e.g., a charging mode corresponding to EPP) as a preferred charging mode from among a plurality of charging modes, based on the wireless power transmission device 200 not supporting a first charging mode (e.g., a charging mode corresponding to MPP). For example, the electronic device 101 may identify the second charging mode as the preferred charging mode from among the plurality of charging modes, without a separate user input, based on the wireless power transmission device 200 not supporting the first charging mode. For example, the electronic device 101 may display a screen for selecting a preferred charging mode based on the wireless power transmission device 200 not supporting the first charging mode, and may identify the second charging mode as the preferred charging mode from among the plurality of charging modes based on a user input,

In operation 1007, according to an embodiment, the electronic device 101 (e.g., the controller 230) may request the wireless power transmission device 200 to discontinue transmission of charging power based on a third charging mode (e.g., a charging mode corresponding to BPP). The wireless power transmission device 200 may discontinue transmission of the charging power and may transmit a ping signal (e.g., a digital ping signal) based on receiving the request to discontinue the transmission of charging power based on the third charging mode.

In operation 1009, according to an embodiment, the electronic device 101 (e.g., the controller 230) may receive a ping signal (e.g., a digital ping signal) (e.g., a second ping signal) from the wireless power transmission device 200.

In operation 1011, according to an embodiment, the electronic device 101 (e.g., the controller 230) may transmit information on a supported charging mode to the wireless power transmission device 200. The electronic device 101 may transmit, as the information on the supported charging mode, information on a second charging mode (e.g., a charging mode corresponding to EPP) identified as a preferred charging mode, to the wireless power transmission device 200. For example, the electronic device 101 may transmit an ID packet including information indicating that an XID packet will be transmitted, and then may transmit the XID packet including information on the second charging mode (e.g., the charging mode corresponding to EPP). For example, the electronic device 101 may transmit an ID packet unrelated to the XID packet, and then may transmit a configuration packet (e.g., a CFG packet) including information on the second charging mode (e.g., the charging mode corresponding to EPP).

In operation 1013, according to an embodiment, the electronic device 101 (e.g., the controller 230) may receive charging power from the wireless power transmission device 200. After transmitting information on a second charging mode (e.g., a charging mode corresponding to EPP) to the wireless power transmission device 200 in operation 1011, the electronic device 101 may receive second charging power from the wireless power transmission device 200 via the wireless charging circuit 220 based on the wireless power transmission device 200 supporting the second charging mode. The electronic device 101 may proceed with a configuration phase and/or a negotiation phase related to the second charging mode with the wireless power transmission device 200 based on the wireless power transmission device 200 supporting the second charging mode, and may receive the second charging power from the wireless power transmission device 200 via the wireless charging circuit 220 based on the second charging mode. The electronic device 101 may identify a preferred charging mode (e.g., a first fast charging mode), transmit information on the charging mode identified as the preferred charging mode to the wireless power transmission device 200, and based on the wireless power transmission device 200 not supporting the preferred charging mode, may receive charging power from the wireless power transmission device 200 via the wireless charging circuit 220 based on another charging mode (e.g., a second fast charging mode).

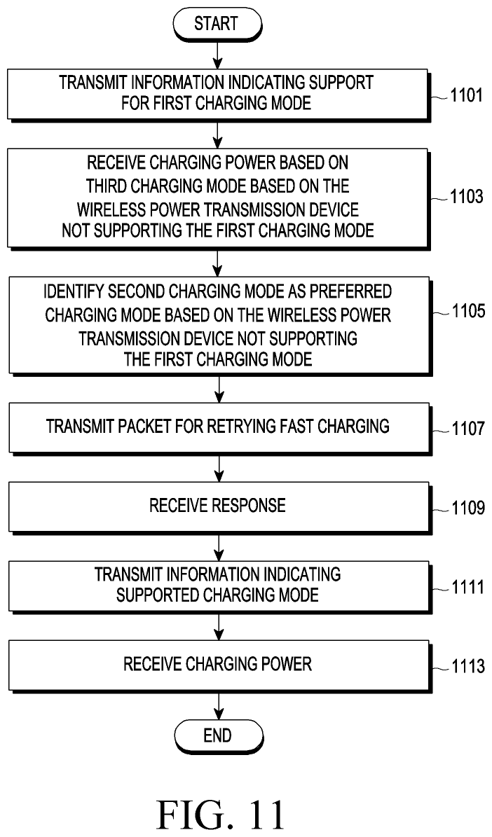

FIG. 11 is a flowchart of a method of operating an electronic device according to an embodiment of the disclosure.

FIG. 11 may be described with reference to the embodiment described above.

At least some of the operations of FIG. 11 may be omitted. An execution order of the operations of FIG. 11 may be changed. Operations other than those of FIG. 11 may be performed before, during, or after the execution of the operations of FIG. 11.

Referring to FIG. 11, in operation 1101, according to an embodiment, the electronic device 101 (e.g., the controller 230) may transmit, to the wireless power transmission device 200, information indicating that a first charging mode (e.g., a charging mode corresponding to MPP) is supported. For example, in operation 609, the electronic device 101 may transmit, to the wireless power transmission device 200, information indicating that the first charging mode (e.g., the charging mode corresponding to MPP) is supported.

In operation 1103, according to an embodiment, the electronic device 101 (e.g., the controller 230) may receive charging power from the wireless power transmission device 200 via the wireless charging circuit 220, based on a third charging mode (e.g., a charging mode corresponding to BPP) supported by the wireless power transmission device 200, and based on the wireless power transmission device 200 not supporting the first charging mode. For example, the electronic device 101 may attempt charging in the first fast charging mode (e.g., a charging mode corresponding to MPP), but may receive charging power from the wireless power transmission device 200 based on a slow charging mode (e.g., a charging mode corresponding to BPP), based on the wireless power transmission device 200 not supporting the first fast charging mode.

In operation 1105, according to an embodiment, the electronic device 101 (e.g., the controller 230) may identify a second charging mode (e.g., a charging mode corresponding to EPP) as a preferred charging mode from among a plurality of charging modes, based on the wireless power transmission device 200 not supporting the first charging mode (e.g., a charging mode corresponding to MPP). For example, the electronic device 101 may identify the second charging mode as the preferred charging mode from among the plurality of charging modes without a separate user input, based on the wireless power transmission device 200 not supporting the first charging mode. For example, the electronic device 101 may display a screen for selecting a preferred charging mode based on the wireless power transmission device 200 not supporting the first charging mode, and may identify the second charging mode as the preferred charging mode from among the plurality of charging modes based on a user input.

In operation 1107, according to an embodiment, the electronic device 101 (e.g., the controller 230) may transmit a packet for retrying fast charging. The electronic device 101 may transmit the packet for retrying fast charging to the wireless power transmission device 200 while receiving charging power based on a third charging mode (e.g., a charging mode corresponding to BPP). There is no limitation on the packet for retrying fast charging. For example, information for retrying fast charging may be included in a property packet (PROP), but this is merely an example. The wireless power transmission device 200 may transmit a response based on receiving the packet for retrying fast charging. For example, the wireless power transmission device 200 may identify a request for retrying fast charging based on a specific field value of the packet for retrying fast charging. The wireless power transmission device 200 may transmit the response to the electronic device 101 to accept the request for retrying fast charging.

In operation 1109, according to an embodiment, the electronic device 101 (e.g., the controller 230) may receive a response to the packet for retrying fast charging from the wireless power transmission device 200.

In operation 1111, according to an embodiment, the electronic device 101 (e.g., the controller 230) may transmit information on a supported charging mode to the wireless power transmission device 200. The electronic device 101 may transmit information on a second charging mode (e.g., a charging mode corresponding to EPP) identified as a preferred charging mode to the wireless power transmission device 200 as the information on the supported charging mode, based on receiving a response to the packet for retrying fast charging. The electronic device 101 may transmit information on the second charging mode (e.g., a charging mode corresponding to EPP) to the wireless power transmission device 200 without receiving a separate ping signal, based on receiving the response to the packet for retrying fast charging. For example, the electronic device 101 may transmit an ID packet including information indicating that an XID packet will be transmitted, and then may transmit the XID packet including information on the second charging mode (e.g., the charging mode corresponding to EPP). For example, the electronic device 101 may transmit an ID packet unrelated to the XID packet, and then may transmit a configuration packet (e.g., a CFG packet) including information on the second charging mode (e.g., the charging mode corresponding to EPP).

In operation 1113, according to an embodiment, the electronic device 101 (e.g., the controller 230) may receive charging power from the wireless power transmission device 200. After transmitting information on a second charging mode (e.g., a charging mode corresponding to EPP) to the wireless power transmission device 200 in operation 1111, the electronic device 101 may receive second charging power from the wireless power transmission device 200 via the wireless charging circuit 220, based on the wireless power transmission device 200 supporting the second charging mode. The electronic device 101 may proceed with a configuration phase and/or a negotiation phase related to the second charging mode with the wireless power transmission device 200, based on the wireless power transmission device 200 supporting the second charging mode, and may receive the second charging power from the wireless power transmission device 200 via the wireless charging circuit 220 based on the second charging mode. The electronic device 101 may identify a preferred charging mode (e.g., a first fast charging mode), transmit information on the charging mode identified as the preferred charging mode to the wireless power transmission device 200, and based on the wireless power transmission device 200 not supporting the preferred charging mode, may receive charging power from the wireless power transmission device 200 via the wireless charging circuit 220 based on another charging mode (e.g., a second fast charging mode).

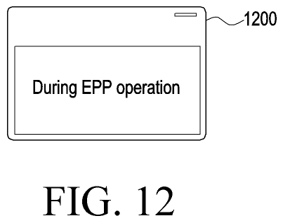

FIG. 12 is a diagram illustrating an operation of an electronic device according to an embodiment of the disclosure.

According to an embodiment, the electronic device 101 (e.g., the controller 230) may display, on a display 410 (e.g., the display module 160), a screen (e.g., 1200) indicating a charging mode based on which charging power is being received. According to the embodiments illustrated in FIGS. 10 and 11, the electronic device 101 may receive charging power from the wireless power transmission device 200 based on a charging mode (e.g., a second charging mode) different from a preferred charging mode (e.g., a first charging mode) initially selected by the user. In this case, it may be necessary for the user to recognize which charging mode is currently being used to receive charging power. The electronic device 101 may display the screen 1200 indicating that charging power is being received based on the second charging mode (e.g., a charging mode corresponding to EPP) after performing operation 1013 of FIG. 10 or operation 1113 of FIG. 11. According to an embodiment, the electronic device 101 (e.g., the controller 230) may display a screen indicating that charging power is being received based on a first charging mode (e.g., a charging mode corresponding to MPP) after performing operation 611 of FIG. 6. According to an embodiment, the electronic device 101 (e.g., the controller 230) may display a screen indicating that charging power is being received based on the first charging mode (e.g., the charging mode corresponding to MPP) or a screen 1200 indicating that charging power is being received based on a second charging mode (e.g., a charging mode corresponding to EPP).

According to an embodiment, based on receiving charging power from the wireless power transmission device 200 through a charging mode (e.g., a second charging mode) different from a preferred charging mode (e.g., a first charging mode) initially selected by the user, the electronic device 101 (e.g., the controller 230) may display a screen simply indicating that fast charging is being performed, without providing guidance on the mode.

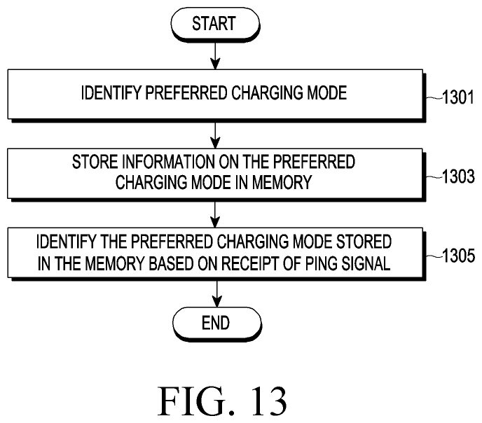

FIG. 13 is a flowchart illustrating a method of operating an electronic device according to an embodiment of the disclosure.

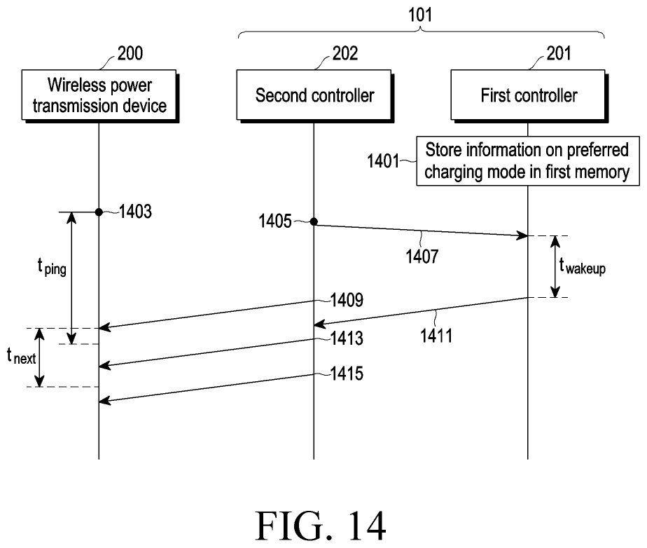

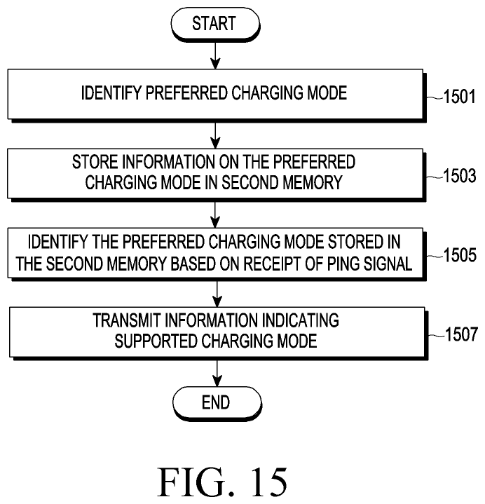

FIG. 13 may be described with reference to the embodiments described above and illustrated in FIGS. 14 and 15.

FIG. 14 is a flowchart illustrating a method of operating an electronic device according to an embodiment of the disclosure.

FIG. 15 is a flowchart illustrating a method of operating an electronic device according to an embodiment of the disclosure.

At least some of the operations of FIG. 13 may be omitted. An execution order of the operations of FIG. 13 may be changed. Operations other than those of FIG. 13 may be performed before, during, or after the execution of the operations of FIG. 13.

Referring to FIG. 13, in operation 1301, according to an embodiment, the electronic device 101 (e.g., the controller 230) may identify a preferred charging mode. For example, the electronic device 101 may identify the preferred charging mode based on a user input, as in the embodiment of FIG. 9. For example, the electronic device 101 may identify the preferred charging mode based on an event (e.g., operation 1005 or operation 1105), as in the embodiments of FIG. 10 or 11.

In operation 1303, according to an embodiment, the electronic device 101 (e.g., the controller 230) may store information on a preferred charging mode in the memory 240. The electronic device 101 may store the information on the preferred charging mode in the memory 240 based on having identified the preferred charging mode from among a plurality of charging modes. For example, the electronic device 101 may store the information on the preferred charging mode in the memory 240 based on a user input before a charging operation is performed (e.g., before receiving a ping signal from the wireless power transmission device 200).

In operation 1305, according to an embodiment, the electronic device 101 (e.g., the controller 230) may identify a preferred charging mode stored in the memory 240 based on having received a ping signal from the wireless power transmission device 200.

Referring to FIG. 14, the embodiment of FIG. 13 may be described in more detail. FIG. 14 illustrates an embodiment in which information on a preferred charging mode is stored in first memory 241 (e.g., the memory 130 of FIG. 1) in the memory 240.

At least some of the operations of FIG. 14 may be omitted. An execution order of the operations of FIG. 14 may be changed. Operations other than those of FIG. 14 may be performed before, during, or after the execution of the operations of FIG. 14.

Referring to FIG. 14, in operation 1401, according to an embodiment, the electronic device 101 (e.g., the controller 230, e.g., a first controller 201) may store information on a preferred charging mode in first memory 241. The electronic device 101 may identify a preferred charging mode in operation 1301 and, in operation 1303, may cause the first controller 201 (e.g., the processor 120 of FIG. 1) to store information on the preferred charging mode in the first memory 241. The electronic device 101 may store information on the preferred charging mode in the first memory 241 before a charging operation is performed (for example, before receiving a ping signal from the wireless power transmission device 200). For example, based on a user input, the electronic device 101 may store information on the preferred charging mode in the memory 240.

In operation 1403, according to an embodiment, the wireless power transmission device 200 may transmit a ping signal (e.g., a digital ping signal).

In operation 1405, according to an embodiment, the electronic device 101 (e.g., the controller 230, e.g., a second controller 202) may receive the ping signal. The second controller 202 (e.g., a controller corresponding to the wireless charging circuit 220) may determine that a voltage (e.g., Vrect) at an output terminal of a rectifier of the wireless charging circuit 220 is equal to or greater than a reference voltage.

In operation 1407, according to an embodiment, the electronic device 101 (e.g., the controller 230, e.g., a second controller 202) may transmit an interrupt signal (e.g., a signal indicating reception of the ping signal) to the first controller 201, based on receiving the ping signal (e.g., the voltage (e.g., Vrect) at the output terminal of the rectifier being equal to or greater than a reference voltage). The second controller 202 and the first controller 201 may transmit and receive signals via a general-purpose input/output (GPIO) or an inter-integrated circuit (I2C).

The first controller 201 (e.g., the processor 120 of FIG. 1) may receive an interrupt signal (e.g., a signal indicating reception of the ping signal) from the second controller 202 (e.g., a controller corresponding to the wireless charging circuit 220). When in a sleep state, the first controller 201 (e.g., the processor 120 of FIG. 1) may switch to an active state based on receiving the interrupt signal (e.g., a signal indicating reception of the ping signal) from the second controller 202 (e.g., a controller corresponding to the wireless charging circuit 220), and may identify information on a preferred charging mode stored in the first memory 241. When in an active state, the first controller 201 (e.g., the processor 120 of FIG. 1) may identify information on the preferred charging mode stored in the first memory 241 based on receiving the interrupt signal (e.g., a signal indicating reception of the ping signal) from the second controller 202 (e.g., a controller corresponding to the wireless charging circuit 220).

In operation 1409, according to an embodiment, the electronic device 101 (e.g., the controller 230, e.g., a second controller 202) may transmit a packet (e.g., a signal strength packet (SSP)) to the wireless power transmission device 200 via the wireless charging circuit 220 based on reception of a ping signal (e.g., where a voltage (e.g., Vrect) at an output terminal of a rectifier is equal to or greater than a reference voltage). The electronic device 101 (e.g., the controller 230, e.g., the second controller 202) may transmit the packet (e.g., the signal strength packet (SSP)) to the wireless power transmission device 200 via the wireless charging circuit 220 within a reference time (e.g., tping) from a time at which the wireless power transmission device 200 transmits the ping signal.

In operation 1411, according to an embodiment, the electronic device 101 (e.g., the controller 230, e.g., a first controller 201) may transmit information on a preferred charging mode stored in the first memory 241 to a second controller 202. For example, the first controller 201 may identify the preferred charging mode stored in the first memory 241 based on receiving an interrupt signal from the second controller 202 and may transmit information on the preferred charging mode to the second controller 202. The first controller 201 may transmit the information on the preferred charging mode stored in the first memory 241 to the second controller 202 within a reference time (e.g., twakeup) from a time at which the interrupt signal is received, based on receiving the interrupt signal from the second controller 202.

In operation 1413, according to an embodiment, the electronic device 101 (e.g., the controller 230, e.g., a second controller 202) may transmit, to the wireless power transmission device 200, an ID packet including information indicating that an XID packet will be transmitted, based on receiving information on a preferred charging mode stored in the first memory 241 from the first controller 201. The electronic device 101 may transmit, to the wireless power transmission device 200, the ID packet including information indicating that the XID packet will be transmitted, within a reference time (e.g., tnext) from a time at which the wireless power transmission device 200 receives the packet (e.g., the signal strength packet (SSP)) in operation 1409.

In operation 1415, according to an embodiment, the electronic device 101 (e.g., the controller 230, e.g., a second controller 202) may transmit an XID packet including information on a supported charging mode. For example, the electronic device 101 may transmit, to the wireless power transmission device 200, information indicating that a charging mode (e.g., a first charging mode) identified as a preferred charging mode is supported, based on receiving information on the preferred charging mode stored in the first memory 241 from the first controller 201.

Referring to FIG. 15, the embodiment of FIG. 13 may be described in more detail. FIG. 15 illustrates an embodiment in which information on a preferred charging mode is stored in second memory 242 (e.g., memory corresponding to the wireless charging circuit 220) in the memory 240.

At least some of the operations of FIG. 15 may be omitted. The execution order of the operations of FIG. 15 may be changed. Operations other than those of FIG. 15 may also be performed before, during, or after performing the operations of FIG. 15.

Referring to FIG. 15, in operation 1501, according to an embodiment, the electronic device 101 (e.g., the controller 230) may identify a preferred charging mode. Operation 1501 may be the same as or similar to operation 1301 of FIG. 13.

In operation 1503, according to an embodiment, the electronic device 101 (e.g., the controller 230) may store information on a preferred charging mode in second memory 242 (e.g., memory corresponding to the wireless charging circuit 220). For example, in operation 1303, the electronic device 101 may cause a first controller 201 (e.g., the processor 120 of FIG. 1) to store information on the preferred charging mode in the second memory 242. For example, the electronic device 101 may identify the preferred charging mode in operation 1501 and may cause a second controller 202 (e.g., a controller corresponding to the wireless charging circuit 220) to store information on the preferred charging mode in the second memory 242. The electronic device 101 may store information on the preferred charging mode in the second memory 242 before a charging operation is performed (for example, before receiving a ping signal from the wireless power transmission device 200).

According to an embodiment, the electronic device 101 (e.g., the controller 230, e.g., a second controller 202) may receive a ping signal. The second controller 202 (e.g., a controller corresponding to the wireless charging circuit 220) may determine that a voltage (e.g., Vrect) at an output terminal of a rectifier of the wireless charging circuit 220 is equal to or greater than a reference voltage. The electronic device 101 (e.g., the controller 230, e.g., the second controller 202) may transmit a packet (e.g., a signal strength packet (SSP)) to the wireless power transmission device 200 via the wireless charging circuit 220, based on receiving the ping signal (e.g., where the voltage (e.g., Vrect) at the output terminal of the rectifier is equal to or greater than the reference voltage). The electronic device 101 (e.g., the controller 230, e.g., the second controller 202) may transmit the packet (e.g., the SSP) to the wireless power transmission device 200 within a reference time (e.g., tping) from a time at which the wireless power transmission device 200 transmits the ping signal.

In operation 1505, according to an embodiment, the electronic device 101 (e.g., the controller 230, e.g., a second controller 202) may identify a preferred charging mode stored in second memory 242 based on receiving the ping signal (e.g., where the voltage (e.g., Vrect) at the output terminal of the rectifier is equal to or greater than the reference voltage).

In operation 1507, according to an embodiment, the electronic device 101 (e.g., the controller 230, e.g., a second controller 202) may transmit information indicating a supported charging mode to the wireless power transmission device 200. For example, the electronic device 101 (e.g., the controller 230, e.g., the second controller 202) may transmit, to the wireless power transmission device 200, an ID packet including information indicating that an XID packet will be transmitted, based on identifying a preferred charging mode stored in second memory 242. The electronic device 101 (e.g., the controller 230, e.g., the second controller 202) may transmit, to the wireless power transmission device 200, the ID packet including information indicating that the XID packet will be transmitted within a reference time (e.g., tnext) from a time at which the wireless power transmission device 200 receives the packet (e.g., the signal strength packet (SSP)). The electronic device 101 (e.g., the controller 230, e.g., the second controller 202) may transmit an XID packet including information on a supported charging mode. For example, the electronic device 101 may transmit, to the wireless power transmission device 200, information indicating that a charging mode (e.g., a first charging mode) identified as a preferred charging mode is supported, based on identifying the preferred charging mode stored in the second memory 242.

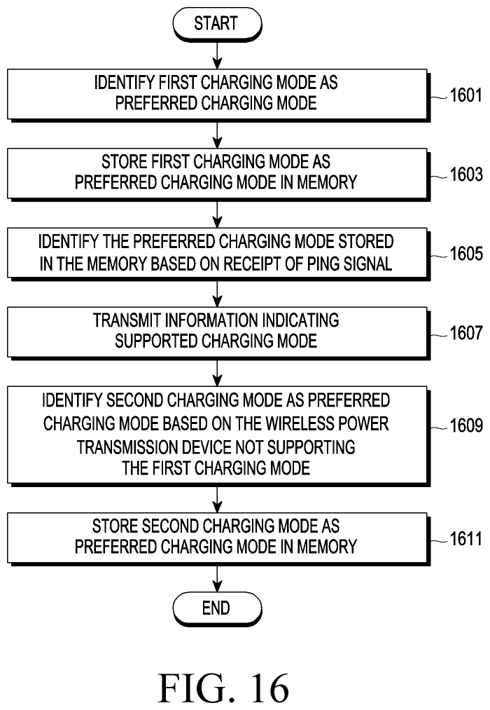

FIG. 16 is a flowchart illustrating a method of operating an electronic device according to an embodiment of the disclosure.

FIG. 16 may be described with reference to the embodiments described above.

At least some of the operations of FIG. 16 may be omitted. The execution order of the operations of FIG. 16 may be changed. Operations other than those of FIG. 16 may be performed before, during, or after the operations of FIG. 16.

Referring to FIG. 16, in operation 1601, according to an embodiment, the electronic device 101 (e.g., the controller 230) may identify a first charging mode as a preferred charging mode. The operation of identifying the first charging mode as the preferred charging mode may be understood with reference to the embodiments described above.

In operation 1603, according to an embodiment, the electronic device 101 (e.g., the controller 230) may store a first charging mode as a preferred charging mode in memory 240 (e.g., first memory 241 or second memory 242). The operation of storing the first charging mode as the preferred charging mode in the memory 240 (e.g., the first memory 241 or the second memory 242) may be understood with reference to the embodiments described above.

In operation 1605, according to an embodiment, the electronic device 101 (e.g., the controller 230) may identify a preferred charging mode stored in memory 240 based on receiving a ping signal. The operation of identifying the preferred charging mode stored in the memory 240 may be understood with reference to the embodiments described above.

In operation 1607, according to an embodiment, the electronic device 101 (e.g., the controller 230) may transmit information on a supported charging mode to the wireless power transmission device 200. The electronic device 101 may transmit information on a first charging mode to the wireless power transmission device 200 as information on the supported charging mode. The operation of transmitting information on the supported charging mode to the wireless power transmission device 200 may be understood with reference to the embodiments described above.

In operation 1609, according to an embodiment, the electronic device 101 (e.g., the controller 230) may identify a second charging mode as a preferred charging mode based on the wireless power transmission device 200 not supporting a first charging mode. The operation of identifying the second charging mode as the preferred charging mode may be understood with reference to the embodiments described above.

In operation 1611, according to an embodiment, the electronic device 101 (e.g., the controller 230) may store the second charging mode as the preferred charging mode in memory 240 (e.g., first memory 241 or second memory 242). The operation of storing the second charging mode as the preferred charging mode in the memory 240 (e.g., the first memory 241 or the second memory 242) may be understood with reference to the embodiments described above.

According to an embodiment, based on the wireless power transmission device 200 not supporting a first charging mode, the electronic device 101 (e.g., the controller 230) may store, in memory 240 (e.g., first memory 241 or second memory 242), information indicating that the wireless power transmission device 200 does not support the first charging mode, by mapping the information with information (e.g., an ID) of the wireless power transmission device 200.

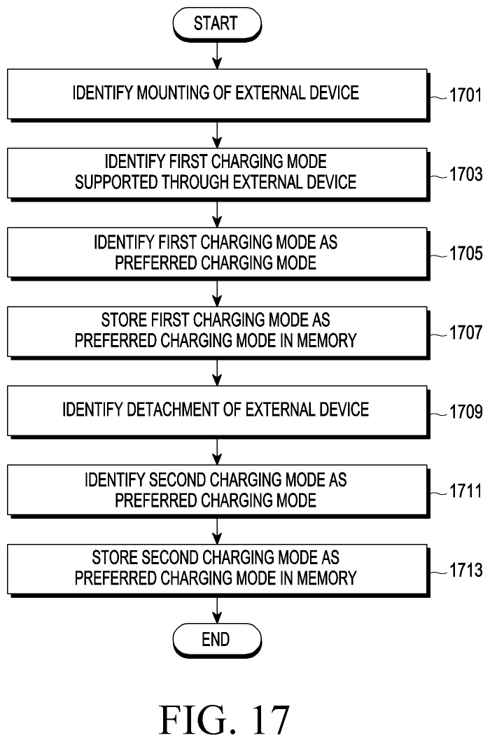

FIG. 17 is a flowchart illustrating a method of operating an electronic device according to an embodiment of the disclosure.

FIG. 17 may be described with reference to the embodiments described above.

At least some of the operations of FIG. 17 may be omitted. The execution order of the operations of FIG. 17 may be changed. Operations other than those of FIG. 17 may also be performed before, during, or after performing the operations of FIG. 17.

Referring to FIG. 17, in operation 1701, according to an embodiment, the electronic device 101 (e.g., the controller 230) may identify a mounting of the external device 300. The operation of identifying the mounting of the external device 300 may be understood with reference to the embodiments described above.

In operation 1703, according to an embodiment, the electronic device 101 (e.g., the controller 230) may identify a first charging mode. The operation of identifying the first charging mode may be understood with reference to the embodiments described above.

In operation 1705, according to an embodiment, the electronic device 101 (e.g., the controller 230) may identify the first charging mode as a preferred charging mode. The operation of identifying the first charging mode as the preferred charging mode may be understood with reference to the embodiments described above.

In operation 1707, according to an embodiment, the electronic device 101 (e.g., the controller 230) may store the first charging mode as a preferred charging mode in memory 240 (e.g., first memory 241 or second memory 242). The operation of storing the first charging mode as the preferred charging mode in the memory 240 (e.g., the first memory 241 or the second memory 242) may be understood with reference to the embodiments described above.

In operation 1709, according to an embodiment, the electronic device 101 (e.g., the controller 230) may identify a detachment of the external device 300. The operation of identifying the detachment of the external device 300 may be understood with reference to the embodiments described above.

In operation 1711, according to an embodiment, the electronic device 101 (e.g., the controller 230) may identify a second charging mode as a preferred charging mode. For example, based on the fact that the electronic device 101 does not support a first charging mode by itself and based on the detachment of the external device 300, the electronic device 101 (e.g., the controller 230) may identify the second charging mode as the preferred charging mode. For example, before identifying the first charging mode as the preferred charging mode in operation 1705, the electronic device 101 (e.g., the controller 230) may identify the second charging mode as the preferred charging mode based on the detachment of the external device 300, and based on the identification of the second charging mode as the preferred charging mode. The operation of identifying the second charging mode as the preferred charging mode may be understood with reference to the embodiments described above.

In operation 1713, according to an embodiment, the electronic device 101 (e.g., the controller 230) may store a second charging mode as a preferred charging mode in memory 240 (e.g., first memory 241 or second memory 242). The operation of storing the second charging mode as the preferred charging mode in the memory 240 (e.g., the first memory 241 or the second memory 242) may be understood with reference to the embodiments described above.

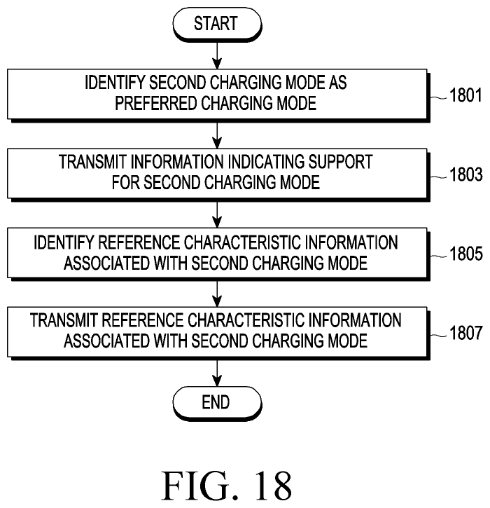

FIG. 18 is a flowchart illustrating a method of operating an electronic device according to an embodiment of the disclosure.

FIG. 18 may be described with reference to the embodiments described above.

At least some of the operations of FIG. 18 may be omitted. The execution order of the operations of FIG. 18 may be changed. Operations other than those of FIG. 18 may also be performed before, during, or after performing the operations of FIG. 18.

Referring to FIG. 18, in operation 1801, according to an embodiment, the electronic device 101 (e.g., the controller 230) may identify a second charging mode as a preferred charging mode. The electronic device 101 may identify the second charging mode as the preferred charging mode in a state where the external device 300 is mounted. The electronic device 101 may identify the second charging mode as the preferred charging mode from among a plurality of charging modes, based on the wireless power transmission device 200 not supporting a first charging mode. The operation of identifying the second charging mode as the preferred charging mode may be understood with reference to the embodiments described above.

In operation 1803, according to an embodiment, the electronic device 101 (e.g., the controller 230) may transmit, to the wireless power transmission device 200 via the wireless charging circuit 220, information indicating that the second charging mode is supported. The operation of transmitting the information indicating that the second charging mode is supported may be understood with reference to the embodiments described above.

In operation 1805, according to an embodiment, the electronic device 101 (e.g., the controller 230) may identify reference characteristic information associated with a second charging mode (e.g., a charging mode corresponding to EPP). The reference characteristic information associated with the second charging mode may include first reference characteristic information and second reference characteristic information. The first reference characteristic information may be reference characteristic information corresponding to a state in which the external device 300 is not mounted. The second reference characteristic information may be reference characteristic information corresponding to a state in which the external device 300 is mounted. The reference characteristic information may be information used by the wireless power transmission device 200 to determine whether to transmit charging power. The reference characteristic information may include a reference quality factor (e.g., Qref) and/or a reference frequency (e.g., Fref) included in a foreign object detection (FOD) packet. For example, in a state where the external device 300 is mounted, the electronic device 101 may identify the second reference characteristic information corresponding to the state in which the external device 300 is mounted as the reference characteristic information. In a state where the external device 300 is not mounted, the electronic device 101 may identify the first reference characteristic information corresponding to the state in which the external device 300 is not mounted as the reference characteristic information.

In operation 1807, according to an embodiment, the electronic device 101 (e.g., the controller 230) may transmit reference characteristic information associated with the second charging mode to the wireless power transmission device 200 via the wireless charging circuit 220. For example, in a state where the external device 300 is mounted, the electronic device 101 may transmit, to the wireless power transmission device 200, second reference characteristic information corresponding to the state in which the external device 300 is mounted as the reference characteristic information. For example, in a state where the external device 300 is not mounted, the electronic device 101 may transmit, to the wireless power transmission device 200, first reference characteristic information corresponding to the state in which the external device 300 is not mounted as the reference characteristic information. The second reference characteristic information corresponding to the state in which the external device 300 is mounted may vary depending on which external device 300 is mounted. The electronic device 101 may transmit the reference characteristic information to the wireless power transmission device 200 via an FOD (foreign object detection) packet during a negotiation phase associated with the second charging mode.

According to an embodiment, the wireless power transmission device 200 may measure characteristic information related to the quality of charging with the electronic device 101. The characteristic information related to the quality of charging with the electronic device 101 may include a quality factor (e.g., Q) and a frequency (e.g., F). The wireless power transmission device 200 may determine whether to transmit charging power to the electronic device 101 based on a difference between reference characteristic information (e.g., first reference characteristic information or second reference characteristic information) received from the electronic device 101 and the characteristic information measured by the wireless power transmission device 200.

According to an embodiment, the electronic device 101 (e.g., the controller 230) may identify first charging information (e.g., a charging mode corresponding to MPP) as a preferred charging mode, transmit information indicating that the first charging mode is supported, and transmit reference characteristic information (e.g., Alpha0, Alpha1, and Alpha K-th of MPP) associated with the first charging mode to the wireless power transmission device 200. The electronic device 101 may transmit a packet (e.g., an XID packet) including information indicating that the first charging mode is supported and the reference characteristic information (e.g., Alpha0, Alpha1, and Alpha K-th of MPP) associated with the first charging mode to the wireless power transmission device 200. The reference characteristic information (e.g., Alpha0, Alpha1, and Alpha K-th of MPP) associated with the first charging mode in a state where the external device 300 is mounted on the electronic device 101 may differ from the reference characteristic information (e.g., Alpha0, Alpha1, and Alpha K-th of MPP) associated with the first charging mode in a state where the external device 300 is not mounted on the electronic device 101. According to an embodiment, the wireless power transmission device 200 may perform MPP K-estimation based on the reference characteristic information (e.g., Alpha0, Alpha1, and Alpha K-th of MPP) associated with the first charging mode received from the electronic device 101. The wireless power transmission device 200 may determine whether to transmit charging power to the electronic device 101 based on a result of the MPP K-estimation.

The embodiments described in the disclosure may be applied interchangeably to the extent that they are applicable, as will be understood by those skilled in the art. For example, it will be understood by those skilled in the art that at least some operations of one embodiment described in the disclosure may be omitted and applied, or at least some operations of one embodiment may be combined and applied with at least some operations of another embodiment.

According to an embodiment, the electronic device 101 may include a housing 320, a wireless charging circuit 220, and at least one controller 230. The at least one controller 230 may be configured to identify a mounting of an external device 300 on a housing 320. The at least one controller 230 may be configured to identify a first charging mode based on the mounting of the external device 300. The at least one controller 230 may be configured to identify the first charging mode as a preferred charging mode from among a plurality of charging modes including the first charging mode. The at least one controller 230 may be configured to receive a first ping signal from a wireless power transmission device 200 via the wireless charging circuit 220. The at least one controller 230 may be configured to transmit, to the wireless power transmission device 200 via the wireless charging circuit 220, information indicating that the first charging mode is supported, based on receiving the first ping signal. Based on the wireless power transmission device 200 supporting the first charging mode, the at least one controller 230 may be configured to receive first charging power from the wireless power transmission device 200 via the wireless charging circuit 220, based on the first charging mode.

According to an embodiment, the external device 300 may include a magnet 310. The at least one controller 230 may be configured to identify that the first charging mode associated with the magnet 310 of the external device 300 is supported, based on the mounting of the external device 300.

According to an embodiment, the electronic device 101 may include a digitizer 420. The at least one controller 230 may be configured to identify the mounting of the external device 300 based on a difference between first sensitivities of a first region of the digitizer 420 at a first time and a second time, and/or a difference between second sensitivities of a second region of the digitizer 420 at the first time and the second time.

According to an embodiment, the at least one controller 230 may be configured to identify a second charging mode as the preferred charging mode from among the plurality of charging modes, based on a detachment of the external device 300.

According to an embodiment, a first frequency range corresponding to the first charging mode may differ from a second frequency range corresponding to the second charging mode.

According to an embodiment, the first charging mode may correspond to a Magnetic Power Profile (MPP), and the second charging mode may correspond to an Extended Power Profile (EPP).

According to an embodiment, the electronic device 101 may include a display (160; 410). The at least one controller 230 may be configured to control the display (160; 410) to display a first screen for selecting one of a plurality of charging modes supported by the electronic device 101, based on the mounting of the external device 300. The at least one controller 230 may be configured to identify, based on a first user input via the first screen, the preferred charging mode from among the plurality of charging modes.

According to an embodiment, based on the wireless power transmission device 200 not supporting the first charging mode, the at least one controller 230 may be configured to receive charging power from the wireless power transmission device 200 via the wireless charging circuit 220, based on a third charging mode supported by the wireless power transmission device 200.

According to an embodiment, the at least one controller 230 may be configured to identify a second charging mode from among the plurality of charging modes as a preferred charging mode, based on the wireless power transmission device 200 not supporting the first charging mode. The at least one controller 230 may be configured to request the wireless power transmission device 200 to discontinue transmission of the charging power, based on the third charging mode. Based on receiving a second ping signal from the wireless power transmission device 200, the at least one controller 230 may be configured to transmit information indicating that the second charging mode is supported to the wireless power transmission device 200. The at least one controller 230 may be configured to receive, based on the wireless power transmission device 200 supporting the second charging mode, second charging power from the wireless power transmission device 200 via the wireless charging circuit 220 based on the second charging mode.

According to an embodiment, the at least one controller 230 may be configured to identify a second charging mode from among a plurality of charging modes as a preferred charging mode, based on the wireless power transmission device 200 not supporting a first charging mode. The at least one controller 230 may be configured to transmit, to the wireless power transmission device 200, a packet for retrying fast charging while receiving charging power based on a third charging mode. The at least one controller 230 may be configured to transmit, to the wireless power transmission device 200, information indicating that the second charging mode is supported, based on receiving a response to the packet for retrying fast charging from the wireless power transmission device 200. Based on the wireless power transmission device 200 supporting the second charging mode, the at least one controller 230 may be configured to receive second charging power via the wireless charging circuit 220 from the wireless power transmission device 200 based on the second charging mode.

According to an embodiment, the electronic device 101 may include a display 160; 410. The at least one controller 230 may be configured to control the display 160; 410 to display a second screen indicating that first charging power is being received based on a first charging mode, or a third screen indicating that second charging power is being received based on a second charging mode.

According to an embodiment, the electronic device 101 may include memory 240. Based on identifying the first charging mode as the preferred charging mode, the at least one controller 230 may be configured to store, in the memory 240, the first charging mode as the preferred charging mode.

According to an embodiment, based on the wireless power transmission device 200 not supporting the first charging mode, the at least one controller 230 may be configured to store, in the memory 240, a second charging mode from among a plurality of charging modes as the preferred charging mode.

According to an embodiment, the memory 240 may include first memory 241. The at least one controller 230 may include a first controller 201 and a second controller 202. The first controller 201 may be configured to store, in the first memory 241, the first charging mode as the preferred charging mode based on identifying the first charging mode as the preferred charging mode. The second controller 202 may be configured to transmit an interrupt signal to the first controller 201 based on receiving the first ping signal. The first controller 201 may be configured to identify the first charging mode stored as the preferred charging mode in the first memory 241 based on receiving the interrupt signal, and transmit information on the first charging mode to the second controller 202. The second controller 202 may be configured to transmit information indicating that the first charging mode is supported to the wireless power transmission device 200 via the wireless charging circuit 220.

According to an embodiment, the memory 240 may include second memory 242. The at least one controller 230 may include a first controller 201 and a second controller 202. The first controller 201 may be configured to store, in the second memory 242, the first charging mode as the preferred charging mode based on identifying the first charging mode as the preferred charging mode. The second controller 202 may be configured to identify the first charging mode stored as the preferred charging mode in the second memory 242 based on receiving the first ping signal. The second controller 202 may be configured to transmit information indicating that the first charging mode is supported to the wireless power transmission device 200 via the wireless charging circuit 220.

According to an embodiment, the at least one controller 230 may be configured to identify, from among a plurality of charging modes, a second charging mode as a preferred charging mode based on the wireless power transmission device 200 not supporting a first charging mode. The at least one controller 230 may be configured to transmit information indicating that the second charging mode is supported to the wireless power transmission device 200 via the wireless charging circuit 220. The at least one controller 230 may be configured to transmit reference characteristic information associated with the second charging mode to the wireless power transmission device 200 via the wireless charging circuit 220.

According to an embodiment, the at least one controller 230 may be configured to identify, as reference characteristic information, second reference characteristic information corresponding to a state in which the external device 300 is mounted, which is different from first reference characteristic information corresponding to a state in which the external device 300 is not mounted. The at least one controller 230 may be configured to transmit the second reference characteristic information to the wireless power transmission device 200. The wireless power transmission device 200 may be configured to measure characteristic information related to a quality of charging with the electronic device 101. The wireless power transmission device 200 may be configured to determine whether to transmit charging power to the electronic device 101 based on a difference between the second reference characteristic information and the characteristic information.

According to an embodiment, a method of operating the electronic device 101 may include identifying a mounting of an external device 300 on a housing 320 of the electronic device 101. The method may include identifying a first charging mode based on the mounting of the external device 300. The method may include identifying the first charging mode as a preferred charging mode from among a plurality of charging modes including the first charging mode. The method may include receiving a first ping signal from a wireless power transmission device 200 via a wireless charging circuit 220 of the electronic device 101. The method may include transmitting, to the wireless power transmission device 200 via the wireless charging circuit 220, information indicating that the first charging mode is supported, based on receiving the first ping signal. The method may include receiving, based on the wireless power transmission device 200 supporting the first charging mode, first charging power from the wireless power transmission device 200 via the wireless charging circuit 220 based on the first charging mode.

According to an embodiment, the external device 300 may include a magnet 310. The operation of identifying the first charging mode may include identifying that the first charging mode associated with the magnet 310 of the external device 300 is supported, based on the mounting of the external device 300.

According to an embodiment, the operation of identifying the mounting of the external device 300 may include identifying the mounting of the external device 300 based on a difference between first sensitivities of a first region of a digitizer 420 and second sensitivities of a second region of the digitizer 420 of the electronic device 101.

According to an embodiment, the method may include identifying a second charging mode from among a plurality of charging modes as a preferred charging mode based on a detachment of the external device 300.

According to an embodiment, a first frequency range corresponding to the first charging mode may differ from a second frequency range corresponding to the second charging mode.

According to an embodiment, the first charging mode may correspond to a magnetic power profile (MPP), and the second charging mode may correspond to an extended power profile (EPP).

According to an embodiment, the method may include displaying a first screen for selecting one of a plurality of charging modes supported by the electronic device 101 based on the mounting of the external device 300. The method may include identifying a preferred charging mode from among the plurality of charging modes based on a first user input through the first screen.

According to an embodiment, the method may include receiving, based on the wireless power transmission device 200 not supporting a first charging mode, charging power from the wireless power transmission device 200 via the wireless charging circuit 220 based on a third charging mode supported by the wireless power transmission device 200.

According to an embodiment, the method may include identifying, from among a plurality of charging modes, a second charging mode as a preferred charging mode based on the wireless power transmission device 200 not supporting the first charging mode. The method may include requesting the wireless power transmission device 200 to discontinue transmission of the charging power based on the third charging mode. The method may include transmitting, to the wireless power transmission device 200, information indicating that the second charging mode is supported, based on receiving a second ping signal from the wireless power transmission device 200. The method may include receiving, based on the wireless power transmission device 200 supporting the second charging mode, second charging power from the wireless power transmission device 200 via the wireless charging circuit 220 based on the second charging mode.

According to an embodiment, the method may include identifying, from among a plurality of charging modes, a second charging mode as a preferred charging mode based on the wireless power transmission device 200 not supporting a first charging mode. The method may include transmitting a packet for retrying fast charging to the wireless power transmission device 200 while receiving charging power based on a third charging mode. The method may include transmitting, based on receiving a response to the packet for retrying fast charging from the wireless power transmission device 200, information indicating that the second charging mode is supported to the wireless power transmission device 200. The method may include receiving, based on the wireless power transmission device 200 supporting the second charging mode, second charging power from the wireless power transmission device 200 via the wireless charging circuit 220 based on the second charging mode.

According to an embodiment, the method may include displaying, based on the first charging mode, a second screen indicating that first charging power is received, or displaying, based on the second charging mode, a third screen indicating that second charging power is received.

According to an embodiment, the method may include storing the first charging mode as a preferred charging mode in memory 240 of the electronic device 101 based on identifying the first charging mode as the preferred charging mode.

According to an embodiment, the method may include storing, in the memory 240, a second charging mode from among a plurality of charging modes as a preferred charging mode based on the wireless power transmission device 200 not supporting the first charging mode.

According to an embodiment, the method may include storing, by a first controller 201 of the electronic device 101, the first charging mode as the preferred charging mode in first memory 241 of the electronic device 101 based on identifying the first charging mode as the preferred charging mode. The operation of transmitting, to the wireless power transmission device 200 via the wireless charging circuit 220, information indicating that the first charging mode is supported, may include transmitting, by a second controller 202 of the electronic device 101, an interrupt signal to the first controller 201 based on receiving the first ping signal. The operation of transmitting, to the wireless power transmission device 200 via the wireless charging circuit 220, information indicating that the first charging mode is supported, may include identifying, by the first controller 201, the first charging mode stored as the preferred charging mode in the first memory 241 based on receiving the interrupt signal. The operation of transmitting, to the wireless power transmission device 200 via the wireless charging circuit 220, information indicating that the first charging mode is supported, may include transmitting, by the first controller 201, information on the first charging mode to the second controller 202. The operation of transmitting, to the wireless power transmission device 200 via the wireless charging circuit 220, information indicating that the first charging mode is supported, may include transmitting, by the second controller 202, the information indicating that the first charging mode is supported to the wireless power transmission device 200 via the wireless charging circuit 220.

According to an embodiment, the method may include storing, by the first controller 201, the first charging mode as the preferred charging mode in the second memory 242 based on identifying the first charging mode as the preferred charging mode. The operation of transmitting, to the wireless power transmission device 200 via the wireless charging circuit 220, information indicating that the first charging mode is supported, may include identifying, by the second controller 202, the first charging mode stored as the preferred charging mode in the second memory 242 based on receiving the first ping signal. The operation of transmitting, to the wireless power transmission device 200 via the wireless charging circuit 220, information indicating that the first charging mode is supported, may include transmitting, by the second controller 202, the information indicating that the first charging mode is supported to the wireless power transmission device 200 via the wireless charging circuit 220.

According to an embodiment, the method may include identifying a second charging mode from among a plurality of charging modes as the preferred charging mode based on the wireless power transmission device 200 not supporting a first charging mode. The method may include transmitting, to the wireless power transmission device 200 via the wireless charging circuit 220, information indicating that the second charging mode is supported. The method may include transmitting reference characteristic information associated with the second charging mode to the wireless power transmission device 200 via the wireless charging circuit 220.

According to an embodiment, the operation of transmitting the reference characteristic information to the wireless power transmission device 200 via the wireless charging circuit 220 may include identifying, as the reference characteristic information, second reference characteristic information corresponding to a state in which the external device 300 is mounted, which is different from first reference characteristic information corresponding to a state in which the external device 300 is not mounted. The operation of transmitting the reference characteristic information to the wireless power transmission device 200 via the wireless charging circuit 220 may include transmitting the second reference characteristic information to the wireless power transmission device 200. The wireless power transmission device 200 may be configured to measure characteristic information related to the quality of charging with the electronic device 101. The wireless power transmission device 200 may be configured to determine whether to transmit charging power to the electronic device 101 based on a difference between the second reference characteristic information and the characteristic information.

According to an embodiment, a computer-readable recording medium storing instructions configured to cause at least one controller 230 of the electronic device 101 to perform at least one operation is provided. The at least one operation may include identifying that an external device 300 is mounted on a housing 320 of the electronic device 101. The at least one operation may include identifying a first charging mode based on the mounting of the external device 300. The at least one operation may include identifying the first charging mode as a preferred charging mode from among a plurality of charging modes including the first charging mode. The at least one operation may include receiving a first ping signal from a wireless power transmission device 200 via a wireless charging circuit 220 of the electronic device 101. The at least one operation may include transmitting, to the wireless power transmission device 200 via the wireless charging circuit 220, information indicating that the first charging mode is supported, based on receiving the first ping signal. The at least one operation may include receiving, based on the wireless power transmission device 200 supporting the first charging mode, first charging power from the wireless power transmission device 200 mode via the wireless charging circuit 220 based on the first charging mode.

According to an embodiment, the external device 300 may include a magnet 310. The operation of identifying the first charging mode may include identifying that the first charging mode associated with the magnet 310 of the external device 300 is supported, based on the mounting of the external device 300.

According to an embodiment, the operation of identifying the mounting of the external device 300 may include identifying the mounting of the external device 300 based on a difference between first sensitivities of a first region of a digitizer 420 of the electronic device 101 and second sensitivities of a second region of the digitizer 420.

According to an embodiment, the at least one operation may include identifying, based on a detachment of the external device 300, a second charging mode from among a plurality of charging modes as a preferred charging mode.

According to an embodiment, a first frequency range corresponding to the first charging mode may differ from a second frequency range corresponding to the second charging mode.

According to an embodiment, the first charging mode may correspond to a magnetic power profile (MPP), and the second charging mode may correspond to an extended power profile (EPP).

According to an embodiment, the at least one operation may include displaying a first screen for selecting one of a plurality of charging modes supported by the electronic device 101, based on a mounting of the external device 300. The at least one operation may include identifying a preferred charging mode from among the plurality of charging modes based on a first user input through the first screen.

According to an embodiment, the at least one operation may include receiving, based on the wireless power transmission device 200 not supporting a first charging mode, charging power from the wireless power transmission device 200 via the wireless charging circuit 220 based on a third charging mode supported by the wireless power transmission device 200.

According to an embodiment, the at least one operation may include identifying a second charging mode from among a plurality of charging modes as a preferred charging mode, based on the wireless power transmission device 200 not supporting the first charging mode. The at least one operation may include requesting the wireless power transmission device 200 to discontinue transmission of the charging power based on the third charging mode. The at least one operation may include transmitting, to the wireless power transmission device 200, information indicating that the second charging mode is supported, based on receiving a second ping signal from the wireless power transmission device 200. The at least one operation may include receiving, based on the wireless power transmission device 200 supporting the second charging mode, second charging power from the wireless power transmission device 200 via the wireless charging circuit 220 based on the second charging mode.

According to an embodiment, the at least one operation may include identifying a second charging mode from among a plurality of charging modes as a preferred charging mode based on the wireless power transmission device 200 not supporting a first charging mode. The at least one operation may include transmitting, to the wireless power transmission device 200, a packet for retrying fast charging while receiving charging power based on a third charging mode. The at least one operation may include transmitting, to the wireless power transmission device 200, information indicating that the second charging mode is supported, based on receiving a response to the packet for retrying fast charging from the wireless power transmission device 200. The at least one operation may include receiving, based on the wireless power transmission device 200 supporting the second charging mode, second charging power from the wireless power transmission device 200 via the wireless charging circuit 220 based on the second charging mode.

According to an embodiment, the at least one operation may include displaying, based on the first charging mode, a second screen indicating that first charging power is being received, or displaying, based on the second charging mode, a third screen indicating that second charging power is being received.

According to an embodiment, the at least one operation may include storing the first charging mode as a preferred charging mode in memory 240 of the electronic device 101 based on identifying the first charging mode as the preferred charging mode.

According to an embodiment, the at least one operation may include storing, in the memory 240, a second charging mode from among a plurality of charging modes as a preferred charging mode based on the wireless power transmission device 200 not supporting the first charging mode.

According to an embodiment, the at least one operation may include storing, by a first controller 201 of the electronic device 101, a first charging mode as a preferred charging mode in first memory 241 of the electronic device 101 based on identifying the first charging mode as the preferred charging mode. The operation of transmitting, to the wireless power transmission device 200 via the wireless charging circuit 220, information indicating that the first charging mode is supported, may include transmitting, by a second controller 202 of the electronic device 101, an interrupt signal to the first controller 201 based on receiving a first ping signal. The operation of transmitting, to the wireless power transmission device 200 via the wireless charging circuit 220, information indicating that the first charging mode is supported, may include identifying, by the first controller 201, the first charging mode stored as the preferred charging mode in the first memory 241 based on receiving the interrupt signal. The operation of transmitting, to the wireless power transmission device 200 via the wireless charging circuit 220, information indicating that the first charging mode is supported, may include transmitting, by the first controller 201, information on the first charging mode to the second controller 202. The operation of transmitting, to the wireless power transmission device 200 via the wireless charging circuit 220, information indicating that the first charging mode is supported, may include transmitting, by the second controller 202, information indicating that the first charging mode is supported to the wireless power transmission device 200 via the wireless charging circuit 220.

According to an embodiment, the at least one operation may include storing, by a first controller 201, a first charging mode as a preferred charging mode in second memory 242 based on identifying the first charging mode as the preferred charging mode. The operation of transmitting, to the wireless power transmission device 200 via the wireless charging circuit 220, information indicating that the first charging mode is supported, may include identifying, by a second controller 202, the first charging mode stored as the preferred charging mode in the second memory 242 based on receiving a first ping signal. The operation of transmitting, to the wireless power transmission device 200 via the wireless charging circuit 220, information indicating that the first charging mode is supported, may include transmitting, by the second controller 202, information indicating that the first charging mode is supported to the wireless power transmission device 200 via the wireless charging circuit 220.

According to an embodiment, the at least one operation may include identifying a second charging mode from among a plurality of charging modes as a preferred charging mode based on the wireless power transmission device 200 not supporting a first charging mode. The at least one operation may include transmitting information indicating that the second charging mode is supported to the wireless power transmission device 200 via the wireless charging circuit 220. The at least one operation may include transmitting reference characteristic information associated with the second charging mode to the wireless power transmission device 200 via the wireless charging circuit 220.

According to an embodiment, the operation of transmitting the reference characteristic information to the wireless power transmission device 200 via the wireless charging circuit 220 may include identifying, as the reference characteristic information, second reference characteristic information corresponding to a state in which the external device 300 is mounted, which is different from first reference characteristic information corresponding to a state in which the external device 300 is not mounted. The operation of transmitting the reference characteristic information to the wireless power transmission device 200 via the wireless charging circuit 220 may include transmitting the second reference characteristic information to the wireless power transmission device 200. The wireless power transmission device 200 may be configured to measure characteristic information related to a quality of charging with the electronic device 101. The wireless power transmission device 200 may be configured to determine whether to transmit charging power to the electronic device 101 based on a difference between the second reference characteristic information and the characteristic information.

The electronic device according to various embodiments of the disclosure may be one of various types of devices. The electronic devices may include, for example, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “portion,” or “circuitry”. A module may be a single integral component, or a minimum unit or portion thereof, adapted to perform one or more functions. For example, according to an embodiment, the module may be implemented in a form of an application-specific integrated circuit (ASIC).

Various embodiments of the disclosure may be implemented as software (e.g., the program 140) including one or more instructions that are stored in a storage medium (e.g., internal memory 136 or external memory 138) that is leadable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium leadable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc lead only memory (CD-ROM)), or be distributed (e.g., downloaded or uploaded) online via an application store (e.g., Play Store™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or further, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing;
a wireless charging circuit;
memory, comprising one or more storage media, storing instructions; and
at least one processor communicatively coupled to the wireless charging circuit and the memory,
wherein the instructions, when executed by the at least one processor individually or collectively, cause the electronic device to:
identify a mounting of an external device on the housing,
identify a first charging mode, based on the mounting of the external device,
identify the first charging mode as a preferred charging mode from among a plurality of charging modes including the first charging mode,
receive a first ping signal from a wireless power transmission device via the wireless charging circuit,
transmit, to the wireless power transmission device via the wireless charging circuit, information indicating that the first charging mode is supported, based on receiving the first ping signal, and
receive first charging power from the wireless power transmission device via the wireless charging circuit based on the first charging mode and based on the wireless power transmission device supporting the first charging mode.

2. The electronic device of claim 1,
wherein the external device comprises a magnet, and
wherein the instructions, when executed by the at least one processor individually or collectively, further cause the electronic device to identify that the first charging mode associated with the magnet of the external device is supported, based on the mounting of the external device.

3. The electronic device of claim 1, further comprising:
a digitizer,
wherein the instructions, when executed by the at least one processor individually or collectively, further cause the electronic device to identify the mounting of the external device, based on a difference between first sensitivities of a first region of the digitizer at a first time and a second time, and/or a difference between second sensitivities of a second region of the digitizer at the first time and a second time.

4. The electronic device of claim 2, further comprising:
a sensor,
wherein the instructions, when executed by the at least one processor individually or collectively, further cause the electronic device to identify the magnet, based on a sensing value obtained using the sensor.

5. The electronic device of claim 1,
wherein the instructions, when executed by the at least one processor individually or collectively, further cause the electronic device to identify a second charging mode as the preferred charging mode from among the plurality of charging modes, based on detachment of the external device, and
wherein a first frequency range corresponding to the first charging mode is different from a second frequency range corresponding to the second charging mode.

6. The electronic device of claim 5,
wherein the first charging mode corresponds to a magnetic power profile (MPP), and
wherein the second charging mode corresponds to an extended power profile (EPP).

7. The electronic device of claim 1, further comprising:
a display,
wherein the instructions, when executed by the at least one processor individually or collectively, further cause the electronic device to:
control the display to display a first screen for selecting one of the plurality of charging modes supported by the electronic device, based on the mounting of the external device, and
identify, based on a first user input via the first screen, the preferred charging mode from among the plurality of charging modes.

8. The electronic device of claim 1, wherein the instructions, when executed by the at least one processor individually or collectively, further cause the electronic device to receive, based on the first charging mode being unsupported by the wireless power transmission device, charging power via the wireless charging circuit from the wireless power transmission device based on a third charging mode supported by the wireless power transmission device.

9. The electronic device of claim 8, wherein the instructions, when executed by the at least one processor individually or collectively, further cause the electronic device to:
identify, based on the first charging mode being unsupported by the wireless power transmission device, a second charging mode as the preferred charging mode from among the plurality of charging modes;
request the wireless power transmission device to discontinue transmission of the charging power based on the third charging mode;
transmit, to the wireless power transmission device, information indicating that the second charging mode is supported, based on receiving a second ping signal; and
receive, based on the wireless power transmission device supporting the second charging mode, second charging power via the wireless charging circuit from the wireless power transmission device based on the second charging mode.

10. The electronic device of claim 8, wherein the instructions, when executed by the at least one processor individually or collectively, further cause the electronic device to:
identify, based on the first charging mode being unsupported by the wireless power transmission device, a second charging mode as the preferred charging mode from among the plurality of charging modes;
transmit, to the wireless power transmission device, while receiving the charging power based on the third charging mode, a packet for retrying fast charging;
transmit, to the wireless power transmission device, information indicating that the second charging mode is supported, based on receiving, from the wireless power transmission device, a response to the packet for retrying the fast charging; and
receive, based on the wireless power transmission device supporting the second charging mode, second charging power via the wireless charging circuit from the wireless power transmission device based on the second charging mode.

11. The electronic device of claim 10, further comprising:
a display,
wherein the instructions, when executed by the at least one processor individually or collectively, further cause the electronic device to:
control the display to display a second screen indicating that the first charging power is being received based on the first charging mode, or a third screen indicating that the second charging power is being received based on the second charging mode.

12. The electronic device of claim 1, further comprising:
memory,
wherein the instructions, when executed by the at least one processor individually or collectively, further cause the electronic device to:
store the first charging mode as the preferred charging mode in the memory, based on identifying the first charging mode as the preferred charging mode, and
store a second charging mode as the preferred charging mode in the memory, based on the first charging mode being unsupported by the wireless power transmission device.

13. The electronic device of claim 1,
wherein the instructions, when executed by the at least one processor individually or collectively, further cause the electronic device to:
identify, based on the first charging mode being unsupported by the wireless power transmission device, a second charging mode as the preferred charging mode from among the plurality of charging modes,
transmit, to the wireless power transmission device via the wireless charging circuit, information indicating that the second charging mode is supported, and
transmit, to the wireless power transmission device via the wireless charging circuit, reference characteristic information related to the second charging mode,
wherein the instructions, when executed by the at least one processor individually or collectively, further cause the electronic device to:
identify, as the reference characteristic information, second reference characteristic information corresponding to a state in which the external device is mounted, the second reference characteristic information being different from first reference characteristic information corresponding to a state in which the external device is unmounted, and
transmit the second reference characteristic information to the wireless power transmission device, and
wherein the wireless power transmission device is configured to:
measure characteristic information related to a quality of charging with the electronic device, and
determine whether to transmit charging power to the electronic device, based on a difference between the second reference characteristic information and the measured characteristic information.

14. A method of operating an electronic device, the method comprising:
identifying a mounting of an external device on a housing of the electronic device;
identifying a first charging mode based on the mounting of the external device;
identifying the first charging mode as a preferred charging mode from among a plurality of charging modes including the first charging mode;
receiving a first ping signal from a wireless power transmission device via a wireless charging circuit of the electronic device;
transmitting, to the wireless power transmission device via the wireless charging circuit, information indicating that the first charging mode is supported, based on receiving the first ping signal; and
receiving, based on the wireless power transmission device supporting the first charging mode, first charging power from the wireless power transmission device via the wireless charging circuit based on the first charging mode.

15. The method of claim 14,
wherein the external device comprises a magnet, and
wherein the method further includes identifying that the first charging mode associated with the magnet of the external device is supported, based on the mounting of the external device.

16. The method of claim 14, further comprising:
identifying the mounting of the external device, based on a difference between first sensitivities of a first region of a digitizer of the electronic device at a first time and a second time, and/or a difference between second sensitivities of a second region of the digitizer at the first time and a second time.

17. The method of claim 15, further comprising:
identifying the magnet, based on a sensing value obtained using a sensor of the electronic device.

18. The method of claim 14, further comprising:
identifying a second charging mode as the preferred charging mode from among the plurality of charging modes, based on detachment of the external device,
wherein a first frequency range corresponding to the first charging mode is different from a second frequency range corresponding to the second charging mode.

19. The method of claim 18,
wherein the first charging mode corresponds to a magnetic power profile (MPP), and
wherein the second charging mode corresponds to an extended power profile (EPP).

20. One or more non-transitory computer-readable storage media storing one or more computer programs including computer-executable instructions that, when executed by one or more processors of an electronic device individually or collectively, cause the electronic device to perform operations, the operations comprising:
identifying a mounting of an external device on a housing of the electronic device;
identifying a first charging mode based on the mounting of the external device;
identifying the first charging mode as a preferred charging mode from among a plurality of charging modes including the first charging mode;
receiving a first ping signal from a wireless power transmission device via a wireless charging circuit of the electronic device;
transmitting, to the wireless power transmission device via the wireless charging circuit, information indicating that the first charging mode is supported, based on receiving the first ping signal; and
receiving, based on the wireless power transmission device supporting the first charging mode, first charging power from the wireless power transmission device via the wireless charging circuit based on the first charging mode.
